(19) United States
(12) Patent Application Publication
(10) Pub. No.: US 2026/0215416 A1
(43) Pub. Date: Jul. 30, 2026

(54) WETTING SYSTEM FOR AGROCHEMICAL SUSPENSION CONCENTRATES COMPOSITIONS

(71) Applicant: ADAMA MAKHTESHIM LTD., Beer Sheva (IL)

(72) Inventors: Nadya STERN, Beer-Sheva (IL); Yogev DAHAN, Tene Omarim (IL)

(73) Assignee: ADAMA MAKHTESHIM LTD., Beer Sheva (IL)

(21) Appl. No.: 19/145,691

(22) PCT Filed: Jan. 2, 2024
(86) PCT No.: PCT/IL2024/050007

§ 371 Date: Jul. 3, 2025

Related U.S. Application Data
(60) Provisional application No. 63/437,126, filed on Jan. 5, 2023.

(51) Int. Cl. A01N 25/04; A01N 25/30; A01N 43/38; A01N 43/56; A01P 7/04

(52) U.S. Cl. CPC A01N 25/04; A01N 25/30; A01N 43/38; A01N 43/56; A01P 7/04; A01N 2300/00

(57) ABSTRACT

The present invention relates to novel suspension concentrate compositions comprising at least one ketoenol insecticide, at least one mitochondrial complex I electron transport inhibitor insecticide and a unique wetting system which allow to obtain stable formulations.

### TECHNICAL FIELD OF THE INVENTION

The present invention relates to novel suspension concentrate compositions comprising at least one ketoenol insecticide, at least one mitochondrial complex I electron transport inhibitor insecticide and a unique wetting system which allow to obtain stable formulations.

### BACKGROUND OF THE INVENTION

Combining two or more insecticides in a formulation can provide several benefits, including increased efficacy, improved pest control, and reduced potential for the development of insecticide resistance. By combining insecticides with different modes of action, it is possible to target a wider range of pests and provide a more comprehensive solution for pest control. Additionally, using a mixture of insecticides can help to prevent the development of resistance in pests, as the different modes of action of the different insecticides can make it more difficult for pests to adapt and become resistant to the treatment. Overall, using a combination of insecticides in a formulation can be an effective way to improve pest control and protect crops from damage.

One of the main difficulties in formulating a mixture of two or more insecticides is ensuring that the resulting mixture is effective and stable.

Wetting agents are an important part of pesticide and insecticide formulations, as they assure uniform dispersion and proper functioning of the active ingredients in the formulation. Wetting agents help to improve the spread and penetration of the insecticides, which can increase their effectiveness and improve the overall control of pests.

In the agrochemical field there are many types of wetting agents including anionic, cationic, amphoteric and non-ionic character. Finding the right combination of wetting agents for a particular insecticide formulation is important because the properties of the wetting agents can affect their compatibility with the insecticides and their ability to improve the spread and penetration of the insecticides. By selecting wetting agents that are suitable for the insecticides being used, it is possible to optimize the effectiveness and efficiency of the insecticides and improve pest control.

### SUMMARY

The present invention provides an agrochemical suspension concentrate composition comprising:
a. at least one ketoenol insecticide
b. at least one mitochondrial complex I electron transport inhibitor insecticide
c. a wetting system comprising of:
   1. at least one anionic surfactant selected from alkoxylated polyarylphenol, alcohol ethoxylate and or propoxylate phosphate ester, sodium alkyl sulfate, sodium alkyl ether sulfate, alkyl naphthalene sulfonate and alkylbenzene sulfonate;
   2. at least one polysiloxane, wherein the ratio of at least one anionic surfactant to at least one polysiloxane is from 0.1:5 to 5:0.1;
   3. optionally, at least one additional surfactant;
and
d. water.

The present invention is directed to an agrochemical suspension concentrate composition comprising:
a. at least one ketoenol insecticide
b. at least one mitochondrial complex I electron transport inhibitor insecticide
c. a wetting system comprising of:
   1. at least one anionic alkoxylated polyarylphenol
   2. at least one polysiloxane
   3. at least one additional surfactant;
and
d. water.

The present invention is also directed to an agrochemical suspension concentrate composition comprising:
a. spirotetramat
b. fenpyroximate
c. from about 0.5% to about 7% by weight, based on the total weight of the composition of at least one alkoxylayed styrenated phenol
d. from about 0.05% to about 0.5% by weight, based on the total weight of the composition of at least one polyether modified trisiloxane
e. from about 0.5% to about 5% by weight, based on the total weight of the composition of sodium dioctyl sulphosuccinate and/or at least one polyoxyethylenesorbitan monolaurate and
f. water.

### DETAILED DESCRIPTION

### Definitions

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter pertains. The following definitions are provided for clarity.

The term “a” or “an” as used herein includes the singular and the plural, unless specifically stated otherwise. Therefore, the terms “a,” “an,” or “at least one” can be used interchangeably in this application.

As used herein, the verb “comprise” as is used in this description and in the claims and its conjugations are used in its non-limiting sense to mean that items following the word are included, but items not specifically mentioned are not excluded.

As used herein, the term “about” when used in connection with a numerical value includes ±10% from the indicated value. In addition, all ranges directed to the same component or property herein are inclusive of the endpoints, are independently combinable, and include all intermediate points and ranges. It is understood that where a parameter range is provided, all integers within that range, and tenths thereof, are also provided by the invention.

As used herein, the term “effective amount” refers to an amount of the active component that is commercially recommended for use to control and/or prevent pest. The commercially recommended amount for each active component, often specified as application rates of the commercial formulation, may be found on the label accompanying the commercial formulation. The commercially recommended application rates of the commercial formulation may vary depending on factors such as the plant species and the pest to be controlled.

As used herein, the term “pest” includes, but is not limited to, unwanted phytopathogenic harmful fungi, unwanted insect, unwanted nematode, and weed.

As used herein, the term “pesticide” broadly refers to an agent that can be used to prevent, control and/or kill a pest. The term is understood to include but is not limited to fungicides, insecticides, nematicides, herbicides, acaricides, parasiticides or other control agents. For chemical classes and applications, as well as specific compounds of each class, see “The Pesticide Manual Thirteenth Edition” (British Crop Protection Council, Hampshire, U K, 2003), as well as “The e-Pesticide Manual, Version 3” (British Crop Protection Council, Hampshire, U K, 2003-04), the contents of each of which are incorporated herein by reference in their entirety.

As used herein, the term “locus” includes not only areas where the pest may already be developed, but also areas where pests have yet to emerge, and also to areas under cultivation. Locus includes the plant or crop and propagation material of the plant or crop. Locus also includes the area surrounding the plant or crop and the growing media of the plant or crop, such as soil and crop field.

As used herein the term “plant” or “crop” includes reference to whole plants, plant organs (e.g. leaves, stems, twigs, roots, trunks, limbs, shoots, fruits etc.), plant cells, or plant seeds. This term also encompasses plant crops such as fruits, spores, corms, bulbs, rhizomes, sprouts basal shoots, stolons, and buds and other parts of plants, including seedlings and young plants, which are to be transplanted after germination or after emergence from soil. The “plant” or “crop” can be plants which can be obtained by conventional breeding and optimization methods or by biotechnological and genetic engineering methods or combinations of these methods, including the transgenic plants and including the plant varieties which can or cannot be protected by plant breeders' rights.

As used herein the term “ha” refers to hectare.

As used herein, said spirotetramat is cis-spirotetramat or in the form of its cis/trans isomeric mixture.

The present invention provides an agrochemical suspension concentrate composition comprising:
a. at least one ketoenol insecticide
b. at least one mitochondrial complex I electron transport inhibitor insecticide
c. a wetting system comprising of:
   1. at least one anionic surfactant selected from alkoxylated polyarylphenol, alcohol ethoxylate and or propoxylate phosphate ester, sodium alkyl sulfate, sodium alkyl ether sulfate, alkyl naphthalene sulfonate and alkylbenzene sulfonate
   2. at least one polysiloxane, wherein the ratio of at least one anionic surfactant to at least one polysiloxane is from about 0.1:5 to about 5:0.1
   3. optionally, at least one additional surfactant
and
d. water.

In some embodiments, the ketoenol insecticide is selected from spirotetramat, spidoxamat, spiropidion, spirodiclofen, spiromesifen and any combinations thereof. In one embodiment, the ketoenol insecticide is spirotetramat.

In some embodiments, the amount of the ketoenol insecticide is of about 1% to about 60% by weight, based on the total weight of the composition. In some embodiments, the amount of the ketoenol insecticide is of about 1% to about 30% by weight, based on the total weight of the composition. In some embodiments, the amount of the ketoenol insecticide is of about 1% to about 20% by weight, based on the total weight of the composition. In some embodiments, the amount of the ketoenol insecticide is of about 1% to about 15% by weight, based on the total weight of the composition. In some embodiments, the amount of the ketoenol insecticide is of about 1% to about 10% by weight, based on the total weight of the composition.

In some embodiments, the amount of spirotetramat is of about 1% to about 60% by weight, based on the total weight of the composition. In some embodiments, the amount of spirotetramat is of about 1% to about 30% by weight, based on the total weight of the composition. In some embodiments, the amount of spirotetramat is of about 1% to about 20% by weight, based on the total weight of the composition. In some embodiments, the amount of spirotetramat is of about 1% to about 15% by weight, based on the total weight of the composition. In some embodiments, the amount of spirotetramat is of about 1% to about 10% by weight, based on the total weight of the composition.

In some embodiments, the mitochondrial complex I electron transport inhibitors insecticide is selected from fenazaquin, fenpyroximate, pyridaben, pyrimidifen, tebufenpyrad, tolfenpyrad and any combinations thereof. In one embodiment, the mitochondrial complex I electron transport inhibitors insecticide is fenpyroximate.

In some embodiments, the amount of the mitochondrial complex I electron transport inhibitors insecticide is of about 1% to about 40% by weight, based on the total weight of the composition. In some embodiments, the amount of the mitochondrial complex I electron transport inhibitors insecticide is of about 1% to about 30% by weight, based on the total weight of the composition. In some embodiments, the amount of the mitochondrial complex I electron transport inhibitors insecticide is of about 1% to about 20% by weight, based on the total weight of the composition. In some embodiments, the amount of the mitochondrial complex I electron transport inhibitors insecticide is of about 1% to about 10% by weight, based on the total weight of the composition.

In some embodiments, the amount of fenpyroximate is of about 1% to about 40% by weight, based on the total weight of the composition. In some embodiments, the amount of fenpyroximate is of about 1% to about 30% by weight, based on the total weight of the composition. In some embodiments, the amount of fenpyroximate is of about 1% to about 20% by weight, based on the total weight of the composition. In some embodiments, the amount of fenpyroximate is of about 1% to about 10% by weight, based on the total weight of the composition.

In some embodiments, the at least one anionic surfactant selected from alkoxylated polyarylphenol, alcohol ethoxylate and or propoxylate phosphate ester, sodium alkyl sulfate, sodium alkyl ether sulfate, alkyl naphthalene sulfonate and alkylbenzene sulfonate.

In some embodiments, the anionic surfactant is alcohol ethoxylate and/or propoxylate phosphate ester. In some embodiments, the anionic surfactant is alcohol ethoxylate phosphate ester. In some embodiments, the anionic surfactant is alcohol propoxylate phosphate ester. In some embodiments, the anionic surfactant is a combination of alcohol ethoxylate and alcohol propoxylate phosphate ester.

Non limiting examples for alcohol ethoxylate and/or propoxylate phosphate ester are servoxyl VPTZ 3/100, STEPFAC™ 3675, STEPFAC 8181 PT3K, Lubrhophos LF 800, HOSTAPHAT® 1306 and HORDAPHOS 1306.

In some embodiments, the anionic surfactant is sodium alkyl sulfate. In some embodiments, the anionic surfactant is sodium alkyl sulfate wherein the alkyl contains between about 6 to about 18 carbon atoms. In some embodiments, the anionic surfactant is sodium alkyl sulfate wherein the alkyl contains between about 10 to about 16 carbon atoms. In some embodiments, the anionic surfactant is sodium alkyl sulfate wherein the alkyl contains between about 12 to about 14 carbon atoms. In some embodiments, the anionic surfactant is sodium alkyl sulfate wherein the alkyl contains about 12 carbon atoms. In some embodiments, the anionic surfactant is sodium alkyl sulfate wherein the alkyl contains about 14 carbon atoms.

Non limiting examples for sodium alkyl sulfates are sodium dodecyl sulfate, sodium tetradecyl sulfate and

In some embodiments, the anionic surfactant is sodium alkyl ether sulfate. In some embodiments, the anionic surfactant is sodium alkyl ether sulfate wherein the alkyl contains between about 6 to about 18 carbon atoms. In some embodiments, the anionic surfactant is sodium alkyl ether sulfate wherein the alkyl contains between about 10 to about 16 carbon atoms. In some embodiments, the anionic surfactant is sodium alkyl ether sulfate wherein the alkyl contains between about 12 to about 14 carbon atoms. In some embodiments, the anionic surfactant is sodium alkyl ether sulfate wherein the alkyl contains about 12 carbon atoms. In some embodiments, the anionic surfactant is sodium alkyl ether sulfate wherein the alkyl contains about 14 carbon atoms.

In some embodiments, the anionic surfactant is sodium alkyl ether sulfate wherein the alkyl contains between about 6 to about 18 carbon atoms and the degree of ethoxylation is between about one ethylene oxide group to about twenty ethylene oxide group. In some embodiments, the anionic surfactant is sodium alkyl ether sulfate wherein the alkyl contains between about 10 to about 16 carbon atoms and the degree of ethoxylation is between about one ethylene oxide group to about twenty ethylene oxide group. In some embodiments, the anionic surfactant is sodium alkyl ether sulfate wherein the alkyl contains between about 12 to about 14 carbon atoms and the degree of ethoxylation is between about one ethylene oxide group to about twenty ethylene oxide group. In some embodiments, the anionic surfactant is sodium alkyl ether sulfate wherein the alkyl contains about 12 carbon atoms and the degree of ethoxylation is between about one ethylene oxide group to about twenty ethylene oxide group. In some embodiments, the anionic surfactant is sodium alkyl ether sulfate wherein the alkyl contains about 14 carbon atoms and the degree of ethoxylation is between about one ethylene oxide group to about twenty ethylene oxide group.

In some embodiments, the anionic surfactant is sodium alkyl ether sulfate wherein the alkyl contains between about 6 to about 18 carbon atoms and the degree of ethoxylation is between about three ethylene oxide group to about eighteen ethylene oxide group. In some embodiments, the anionic surfactant is sodium alkyl ether sulfate wherein the alkyl contains between about 10 to about 16 carbon atoms and the degree of ethoxylation is between about three ethylene oxide group to about eighteen ethylene oxide group. In some embodiments, the anionic surfactant is sodium alkyl ether sulfate wherein the alkyl contains between about 12 to about 14 carbon atoms and the degree of ethoxylation is between about three ethylene oxide group to about eighteen ethylene oxide group. In some embodiments, the anionic surfactant is sodium alkyl ether sulfate wherein the alkyl contains about 12 carbon atoms and the degree of ethoxylation is between about three ethylene oxide group to about eighteen ethylene oxide group. In some embodiments, the anionic surfactant is sodium alkyl ether sulfate wherein the alkyl contains about 14 carbon atoms and the degree of ethoxylation is between about three ethylene oxide group to about eighteen ethylene oxide group.

In some embodiments, the anionic surfactant is sodium alkyl ether sulfate wherein the alkyl contains between about 6 to about 18 carbon atoms and the degree of ethoxylation is between about ten ethylene oxide group to about sixteen ethylene oxide group. In some embodiments, the anionic surfactant is sodium alkyl ether sulfate wherein the alkyl contains between about 10 to about 16 carbon atoms and the degree of ethoxylation is between about ten ethylene oxide group to about sixteen ethylene oxide group. In some embodiments, the anionic surfactant is sodium alkyl ether sulfate wherein the alkyl contains between about 12 to about 14 carbon atoms and the degree of ethoxylation is between about ten ethylene oxide group to about sixteen ethylene oxide group. In some embodiments, the anionic surfactant is sodium alkyl ether sulfate wherein the alkyl contains about 12 carbon atoms and the degree of ethoxylation is between about ten ethylene oxide group to about sixteen ethylene oxide group. In some embodiments, the anionic surfactant is sodium alkyl ether sulfate wherein the alkyl contains about 14 carbon atoms and the degree of ethoxylation is between about ten ethylene oxide group to about sixteen ethylene oxide group.

Non limiting examples for sodium alkyl ether sulfate are sodium laureth sulfate including sodium Laureth 2 sulfate, sodium Laureth 3 sulfate, sodium Laureth 5 sulfate, sodium Laureth 10 sulfate, and sodium Laureth 12 sulfate.

In some embodiments, the anionic surfactant is alkyl naphthalene sulfonate. In some embodiments, the anionic surfactant is alkyl naphthalene sulfonate wherein the alkyl contains between about 1 to about 16 carbon atoms. In some embodiments, the anionic surfactant is alkyl naphthalene sulfonate wherein the alkyl contains between about 10 to about 13 carbon atoms.

In some embodiments, the alkyl naphthalene sulfonate is selected from sodium n-butyl naphthalene sulfonate, sodium di-isobutyl naphthalene sulfonate, sodium isopropyl naphthalene sulfonate, sodium isopropyl naphthalene sulfonate and any combination thereof.

In some embodiments, the alkyl naphthalene sulfonate is sodium n-butyl naphthalene sulfonate.

In some embodiments, the alkyl naphthalene sulfonate is sodium di-isobutyl naphthalene sulfonate.

In some embodiments, the alkyl naphthalene sulfonate is sodium isopropyl naphthalene sulfonate.

In some embodiments, the alkyl naphthalene sulfonate is sodium isopropyl naphthalene sulfonate.

Non limiting examples for commercial products of alkyl naphthalene sulfonate include Supragil® WP, Morwet EFW Powder, Morwet DB Powder, Morwet DIBS Powder and Morwet IP Powder.

In some embodiments, the anionic surfactant is alkylbenzene sulfonate. In some embodiments, the anionic surfactant is alkylbenzene sulfonate wherein the alkyl contains between about 8 to about 20 carbon atoms. In some embodiments, the anionic surfactant is alkylbenzene sulfonate wherein the alkyl contains between about 10 to about 16 carbon atoms. In some embodiments, the anionic surfactant is alkylbenzene sulfonate wherein the alkyl contains between about 10 to about 13 carbon atoms.

In some embodiments, the alkylbenzene sulfonate is selected from dodecylbenzene sulfonic acid sodium salt, decylbenzene sulfonic acid sodium salt, tridecylbenzene sulfonic acid sodium salt, undecylbenzene sulfonic acid sodium salt, sodium salt of (C10-16)alkylbenzenesulfonate, sodium salt of (C10-13)alkylbenzenesulfonate, C10-14 alkyl benzene sulfonic acid sodium salt, C10-14 monoalkylbenzene sulfonic acid sodium salt, (C10-13)sec alkyl benzene sulfonic acid sodium salt and any combination thereof.

In some embodiments, the alkylbenzene sulfonate is selected from dodecylbenzene sulfonic acid sodium salt, decylbenzene sulfonic acid sodium salt, tridecylbenzene sulfonic acid sodium salt, sodium salt of (C10-16)alkylbenzenesulfonate, sodium salt of (C10-13)alkylbenzenesulfonate, C10-14 alkyl benzene sulfonic acid sodium salt and any combination thereof.

In some embodiments, the alkylbenzene sulfonate is dodecylbenzene sulfonic acid sodium salt.

In some embodiments, the alkylbenzene sulfonate is decylbenzene sulfonic acid sodium salt.

In some embodiments, the alkylbenzene sulfonate is tridecylbenzene sulfonic acid sodium salt.

In some embodiments, the alkylbenzene sulfonate is sodium salt of (C10-16)alkylbenzenesulfonate.

In some embodiments, the alkylbenzene sulfonate is sodium salt of (C10-13)alkylbenzenesulfonate.

In some embodiments, the alkylbenzene sulfonate is C10-14 alkyl benzene sulfonic acid sodium salt.

Non limiting examples for commercial products of alkylbenzene sulfonate include NINATE® 60E, NANSA® EVM 62/H, NANSA® EVM 40/2ND, NANSA® EVM 50/ND, NANSA® EVM 40/2NDL, NANSA® EVM 50/NS, NANSA® EVM 63/B, NANSA® EVM 70/B, NANSA® EVM 62/N, NANSA® EVM 70/13, NANSA® EVM 70/2E, and NANSA® EVM 60/2EG.

In some embodiments, the anionic alkoxylated polyarylphenol is selected from alkoxylated polyarylphenol phosphate, alkoxylated polyarylphenol sulphate and any combination thereof.

In some embodiments, the alkoxylated polyarylphenol phosphate is alkoxylayed tristyrylphenol phosphate.

In some embodiments, the alkoxylayed tristyrylphenol phosphate is 2,4,6-tris(1-phenylethyl)phenol polyoxyethylenated phosphate.

In some embodiments, the number of ethylene oxide unites is of about 16 to about 54. In one embodiment, the number of ethylene oxide unites is of about 16.

In some embodiments, the alkoxylayed tristyrylphenol phosphate is 2,4,6-tris(1-phenylethyl)phenol polyoxyethylenated phosphate with number of ethylene oxide unites of about 16 to about 54.

In some embodiments, the alkoxylayed tristyrylphenol phosphate is 2,4,6-tris(1-phenylethyl)phenol polyoxyethylenated phosphate with number of ethylene oxide unites of about 16.

In some embodiments, the alkoxylayed tristyrylphenol phosphate is 2,4,6-tris(1-phenylethyl)phenol polyoxyethylenated phosphate and the number of ethylene oxide unites is of about 16.

Non limiting examples for alkoxylayed tristyrylphenol phosphate include Soprophor® 3D33, Soprophor® FL, Soprophor® FL-R, Soprophor® SC, Soprophor® FD, Soprophor® FLK, Soprophor® SC3, Soprophor® FLK/70, Soprophor® FL/60 and Soprophor® 3D33 R, Dispersogen TP 160, STEPFAC TSP PE N and SURFOM 1322 SC.

In some embodiments, the alkoxylated polyarylphenol sulphate is selected from alkoxylayed distyrylphenol sulphate, alkoxylayed tristyrylphenol sulphate and any combination thereof.

Non limiting examples for alkoxylated tristyrylphenol sulphate include Soprophor® 4D/384, Tersperse 2218 and LUCRAMUL SPS 16.

In some embodiments, the polysiloxane is a polyether modified trisiloxane.

In some embodiments, the polyether modified trisiloxane is 3-[methyl-bis(trimethylsilyloxy)silyl]propan-1-ol.

Non limiting examples for polysiloxane include BREAK-THRU® S 233, Silwet L-77, Silwet 806 andSilwet 408.

In some embodiments, the ratio of the anionic surfactant to the polysiloxane is from about 0.1:5 to about 5:0.1. In some embodiments, the ratio of the anionic surfactant to the polysiloxane is from about 0.1:2 to about 2:0.1.

In some embodiments, the ratio of the anionic surfactant to the polyether modified trisiloxane is from about 0.1:5 to about 5:0.1. In some embodiments, the ratio of the anionic surfactant to the polyether modified trisiloxane is from about 0.1:2 to about 2:0.1.

In some embodiments, the ratio of the anionic surfactant selected from alkoxylated polyarylphenol, alcohol ethoxylate and/or propoxylate phosphate ester, sodium alkyl sulfate, sodium alkyl ether sulfate, alkyl naphthalene sulfonate and alkylbenzene sulfonate to the polyether modified trisiloxane is from about 0.1:5 to about 5:0.1. In some embodiments, the ratio of the anionic surfactant selected from alkoxylated polyarylphenol, alcohol ethoxylate and/or propoxylate phosphate ester, sodium alkyl sulfate, sodium alkyl ether sulfate, alkyl naphthalene sulfonate and alkylbenzene sulfonate to the polyether modified trisiloxane is from about 0.1:2 to about 2:0.1.

In some embodiments, the ratio of the alkoxylated polyarylphenol to the polyether modified trisiloxane is from about 0.1:5 to about 5:0.1. In some embodiments, the ratio of the alkoxylated polyarylphenol to the polyether modified trisiloxane is from about 0.1:2 to about 2:0.1.

In some embodiments, the ratio of the alcohol ethoxylate and/or propoxylate phosphate ester to the polyether modified trisiloxane is from about 0.1:5 to about 5:0.1. In some embodiments, the ratio of the alcohol ethoxylate and/or propoxylate phosphate ester to the polyether modified trisiloxane is from about 0.1:2 to about 2:0.1.

In some embodiments, the ratio of the alcohol ethoxylate phosphate ester to the polyether modified trisiloxane is from about 0.1:5 to about 5:0.1. In some embodiments, the ratio of the alcohol ethoxylate phosphate ester to the polyether modified trisiloxane is from about 0.1:2 to about 2:0.1.

In some embodiments, the ratio of the sodium alkyl sulfate to the polyether modified trisiloxane is from about 0.1:5 to about 5:0.1. In some embodiments, the ratio of the sodium alkyl sulfate to the polyether modified trisiloxane is from about 0.1:2 to about 2:0.1.

In some embodiments, the ratio of the sodium alkyl ether sulfate to the polyether modified trisiloxane is from about 0.1:5 to about 5:0.1. In some embodiments, the ratio of the sodium alkyl ether sulfate to the polyether modified trisiloxane is from about 0.1:2 to about 2:0.1.

In some embodiments, the ratio of the alkyl naphthalene sulfonate to the polyether modified trisiloxane is from about 0.1:5 to about 5:0.1. In some embodiments, the ratio of the alkyl naphthalene sulfonate to the polyether modified trisiloxane is from about 0.1:2 to about 2:0.1.

In some embodiments, the ratio of the alkylbenzene sulfonate to the polyether modified trisiloxane is from about 0.1:5 to about 5:0.1. In some embodiments, the ratio of the alkylbenzene sulfonate to the polyether modified trisiloxane is from about 0.1:2 to about 2:0.1.

In some embodiments, suitable surfactants are all substances that can enhance the wetting properties of the composition.

In certain embodiments which are not limiting, the surfactant can reduce the surface tension of water, increase the spreading abilities of a liquid, provide good absorption and smooth entrance of the active ingredients into the water.

In some embodiments, the additional surfactant is selected from sodium dioctyl sulphosuccinate, polysorbate, secondary alcohol ethoxylate and any combination thereof.

In some embodiments, the additional surfactant is sodium dioctyl sulphosuccinate.

In some embodiments, the additional surfactant is polysorbate.

In some embodiments, the additional surfactant is secondary alcohol ethoxylate.

In some embodiments, the polysorbate is selected from polyoxyethylene sorbitan monolaurate, polyoxyethylene polyoxypropylen sorbitan monolaurate, polyoxyethylene sorbitan monopalmitate, polyoxyethylene sorbitan monostearate, polyoxyethylene sorbitan monooleate or any combination thereof.

In some embodiments, the polysorbate is polyoxyethylene sorbitan monolaurate.

Non limiting examples of polysorbates include TWEEN® 20, TWEEN® 40, TWEEN® 60 and TWEEN® 80.

In some embodiments, the secondary alcohol ethoxylate is C11-C15 secondary alcohol ethoxylate.

In some embodiments, the secondary alcohol ethoxylate is C12-C14 secondary alcohol ethoxylate.

In some embodiments, the secondary alcohol ethoxylate is C11-C15 secondary alcohol ethoxylate with number of ethylene oxide units of about 3 to about 16. In some embodiments, the secondary alcohol ethoxylate is C11-C15 secondary alcohol ethoxylate with number of ethylene oxide units of about 3 to about 12. In some embodiments, the secondary alcohol ethoxylate is C11-C15 secondary alcohol ethoxylate with number of ethylene oxide units of about 3 to about 9. In one embodiment, the secondary alcohol ethoxylate is C11-C15 secondary alcohol ethoxylate with number of ethylene oxide units of about 9.

In some embodiments, the secondary alcohol ethoxylate is C12-C14 secondary alcohol ethoxylate with number of ethylene oxide units of about 3 to about 16. In some embodiments, the secondary alcohol ethoxylate is C12-C14 secondary alcohol ethoxylate with number of ethylene oxide units of about 3 to about 12. In some embodiments, the secondary alcohol ethoxylate is C12-C14 secondary alcohol ethoxylate with number of ethylene oxide units of about 3 to about 9. In one embodiment, the secondary alcohol ethoxylate is C12-C14 secondary alcohol ethoxylate with number of ethylene oxide units of about 9.

Non limiting example for additional surfactants from secondary alcohol ethoxylate include TERGITOL™ 15-S-9.

In some embodiments, the amount of the alcohol ethoxylate and/or propoxylate phosphate ester is of about 0.5% to about 7% by weight, based on the total weight of the composition. In some embodiments, the amount of the alcohol ethoxylate and/or propoxylate phosphate ester is of about 1% to about 5% by weight, based on the total weight of the composition. In some embodiments, the amount of the alcohol ethoxylate and/or propoxylate phosphate ester is of about 1% to about 3% by weight, based on the total weight of the composition. In some embodiments, the amount of the alcohol ethoxylate and/or propoxylate phosphate ester is of about 1% to about 2% by weight, based on the total weight of the composition.

In some embodiments, the amount of the alcohol ethoxylate phosphate ester is of about 0.5% to about 7% by weight, based on the total weight of the composition. In some embodiments, the amount of the alcohol ethoxylate phosphate ester is of about 1% to about 5% by weight, based on the total weight of the composition. In some embodiments, the amount of the alcohol ethoxylate phosphate ester is of about 1% to about 3% by weight, based on the total weight of the composition. In some embodiments, the amount of the alcohol ethoxylate phosphate ester is of about 1% to about 2% by weight, based on the total weight of the composition.

In some embodiments, the amount of the alcohol propoxylate phosphate ester is of about 0.5% to about 7% by weight, based on the total weight of the composition. In some embodiments, the amount of the alcohol propoxylate phosphate ester is of about 1% to about 5% by weight, based on the total weight of the composition. In some embodiments, the amount of the alcohol propoxylate phosphate ester is of about 1% to about 3% by weight, based on the total weight of the composition. In some embodiments, the amount of the alcohol propoxylate phosphate ester ester is of about 1% to about 2% by weight, based on the total weight of the composition.

In some embodiments, the amount of the sodium alkyl sulfate is of about 0.5% to about 7% by weight, based on the total weight of the composition. In some embodiments, the amount of the sodium alkyl sulfate is of about 1% to about 5% by weight, based on the total weight of the composition. In some embodiments, the amount of the sodium alkyl sulfate is of about 1% to about 3% by weight, based on the total weight of the composition. In some embodiments, the amount of the sodium alkyl sulfate is of about 1% to about 2% by weight, based on the total weight of the composition.

In some embodiments, the amount of the sodium alkyl sulfate wherein the alkyl contains between about 6 to about 18 carbon atoms is of about 0.5% to about 7% by weight, based on the total weight of the composition. In some embodiments, the amount of the sodium alkyl sulfate wherein the alkyl contains between about 6 to about 18 carbon atoms is of about 1% to about 5% by weight, based on the total weight of the composition. In some embodiments, the amount of the sodium alkyl sulfate wherein the alkyl contains between about 6 to about 18 carbon atoms is of about 1% to about 3% by weight, based on the total weight of the composition. In some embodiments, the amount of the sodium alkyl sulfate wherein the alkyl contains between about 6 to about 18 carbon atoms is of about 1% to about 2% by weight, based on the total weight of the composition.

In some embodiments, the amount of the sodium alkyl sulfate wherein the alkyl contains between about 10 to about 16 carbon atoms is of about 0.5% to about 7% by weight, based on the total weight of the composition. In some embodiments, the amount of the sodium alkyl sulfate wherein the alkyl contains between about 10 to about 16 carbon atoms is of about 1% to about 5% by weight, based on the total weight of the composition. In some embodiments, the amount of the sodium alkyl sulfate wherein the alkyl contains between about 10 to about 16 carbon atoms is of about 1% to about 3% by weight, based on the total weight of the composition. In some embodiments, the amount of the sodium alkyl sulfate wherein the alkyl contains between about 10 to about 16 carbon atoms is of about 1% to about 2% by weight, based on the total weight of the composition.

In some embodiments, the amount of the sodium alkyl sulfate wherein the alkyl contains between about 12 to about 14 carbon atoms is of about 0.5% to about 7% by weight, based on the total weight of the composition. In some embodiments, the amount of the sodium alkyl sulfate wherein the alkyl contains between about 12 to about 14 carbon atoms is of about 1% to about 5% by weight, based on the total weight of the composition. In some embodiments, the amount of the sodium alkyl sulfate wherein the alkyl contains between about 12 to about 14 carbon atoms is of about 1% to about 3% by weight, based on the total weight of the composition. In some embodiments, the amount of the sodium alkyl sulfate wherein the alkyl contains between about 12 to about 14 carbon atoms is of about 1% to about 2% by weight, based on the total weight of the composition.

In some embodiments, the amount of the odium alkyl sulfate wherein the alkyl contains about 12 carbon atoms is of about 0.5% to about 7% by weight, based on the total weight of the composition. In some embodiments, the amount of the sodium alkyl sulfate wherein the alkyl contains about 12 carbon atoms is of about 1% to about 5% by weight, based on the total weight of the composition. In some embodiments, the amount of the sodium alkyl sulfate wherein the alkyl contains about 12 carbon atoms is of about 1% to about 3% by weight, based on the total weight of the composition. In some embodiments, the amount of the sodium alkyl sulfate wherein the alkyl contains about 12 carbon atoms is of about 1% to about 2% by weight, based on the total weight of the composition.

In some embodiments, the amount of the sodium alkyl sulfate wherein the alkyl contains about 14 carbon atoms is of about 0.5% to about 7% by weight, based on the total weight of the composition. In some embodiments, the amount of the sodium alkyl sulfate wherein the alkyl contains about 14 carbon atoms is of about 1% to about 5% by weight, based on the total weight of the composition. In some embodiments, the amount of the sodium alkyl sulfate wherein the alkyl contains about 14 carbon atoms is of about 1% to about 3% by weight, based on the total weight of the composition. In some embodiments, the amount of the sodium alkyl sulfate wherein the alkyl contains about 14 carbon atoms is of about 1% to about 2% by weight, based on the total weight of the composition.

In some embodiments, the amount of the sodium alkyl ether sulfate is of about 0.5% to about 7% by weight, based on the total weight of the composition. In some embodiments, the amount of the sodium alkyl ether sulfate is of about 1% to about 5% by weight, based on the total weight of the composition. In some embodiments, the amount of the sodium alkyl ether sulfate is of about 1% to about 3% by weight, based on the total weight of the composition. In some embodiments, the amount of the sodium alkyl ether sulfate is of about 1% to about 2% by weight, based on the total weight of the composition.

In some embodiments, the amount of the sodium alkyl ether sulfate wherein the alkyl contains between about 6 to about 18 carbon atoms is of about 0.5% to about 7% by weight, based on the total weight of the composition. In some embodiments, the amount of the sodium alkyl ether sulfate wherein the alkyl contains between about 6 to about 18 carbon atoms is of about 1% to about 5% by weight, based on the total weight of the composition. In some embodiments, the amount of the sodium alkyl ether sulfate wherein the alkyl contains between about 6 to about 18 carbon atoms is of about 1% to about 3% by weight, based on the total weight of the composition. In some embodiments, the amount of the sodium alkyl ether sulfate wherein the alkyl contains between about 6 to about 18 carbon atoms is of about 1% to about 2% by weight, based on the total weight of the composition.

In some embodiments, the amount of the sodium alkyl ether sulfate wherein the alkyl contains between about 10 to about 16 carbon atoms is of about 0.5% to about 7% by weight, based on the total weight of the composition. In some embodiments, the amount of the sodium alkyl ether sulfate wherein the alkyl contains between about 10 to about 16 carbon atoms is of about 1% to about 5% by weight, based on the total weight of the composition. In some embodiments, the amount of the sodium alkyl ether sulfate wherein the alkyl contains between about 10 to about 16 carbon atoms is of about 1% to about 3% by weight, based on the total weight of the composition. In some embodiments, the amount of the sodium alkyl ether sulfate wherein the alkyl contains between about 10 to about 16 carbon atoms is of about 1% to about 2% by weight, based on the total weight of the composition.

In some embodiments, the amount of the sodium alkyl ether sulfate wherein the alkyl contains between about 12 to about 14 carbon atoms is of about 0.5% to about 7% by weight, based on the total weight of the composition. In some embodiments, the amount of the sodium alkyl ether sulfate wherein the alkyl contains between about 12 to about 14 carbon atoms is of about 1% to about 5% by weight, based on the total weight of the composition. In some embodiments, the amount of the sodium alkyl ether sulfate wherein the alkyl contains between about 12 to about 14 carbon atoms is of about 1% to about 3% by weight, based on the total weight of the composition. In some embodiments, the amount of the sodium alkyl ether sulfate wherein the alkyl contains between about 12 to about 14 carbon atoms is of about 1% to about 2% by weight, based on the total weight of the composition.

In some embodiments, the amount of the sodium alkyl ether sulfate wherein the alkyl contains about 12 carbon atoms is of about 0.5% to about 7% by weight, based on the total weight of the composition. In some embodiments, the amount of the sodium alkyl ether sulfate wherein the alkyl contains about 12 carbon atoms is of about 1% to about 5% by weight, based on the total weight of the composition. In some embodiments, the amount of the sodium alkyl ether sulfate wherein the alkyl contains about 12 carbon atoms is of about 1% to about 3% by weight, based on the total weight of the composition. In some embodiments, the amount of the sodium alkyl ether sulfate wherein the alkyl contains about 12 carbon atoms is of about 1% to about 2% by weight, based on the total weight of the composition.

In some embodiments, the amount of the sodium alkyl ether sulfate wherein the alkyl contains about 14 carbon atoms is of about 0.5% to about 7% by weight, based on the total weight of the composition. In some embodiments, the amount of the sodium alkyl ether sulfate wherein the alkyl contains about 14 carbon atoms is of about 1% to about 5% by weight, based on the total weight of the composition. In some embodiments, the amount of the sodium alkyl ether sulfate wherein the alkyl contains about 14 carbon atoms is of about 1% to about 3% by weight, based on the total weight of the composition. In some embodiments, the amount of the sodium alkyl ether sulfate wherein the alkyl contains about 14 carbon atoms is of about 1% to about 2% by weight, based on the total weight of the composition.

In some embodiments, the amount of sodium laureth sulfate is of about 0.5% to about 7% by weight, based on the total weight of the composition. In some embodiments, the amount of sodium laureth sulfate is of about 1% to about 5% by weight, based on the total weight of the composition. In some embodiments, the amount of sodium laureth sulfate is of about 1% to about 3% by weight, based on the total weight of the composition. In some embodiments, the amount of sodium laureth sulfate is of about 1% to about 2% by weight, based on the total weight of the composition.

In some embodiments, the amount of the alkyl naphthalene sulfonate is of about 0.5% to about 7% by weight, based on the total weight of the composition. In some embodiments, the amount of the alkyl naphthalene sulfonate is of about 1% to about 5% by weight, based on the total weight of the composition. In some embodiments, the amount of the alkyl naphthalene sulfonate is of about 1% to about 3% by weight, based on the total weight of the composition. In some embodiments, the amount of the alkyl naphthalene sulfonate is of about 1% to about 2% by weight, based on the total weight of the composition.

In some embodiments, the amount of the alkyl naphthalene sulfonate wherein the alkyl contains between about 1 to about 16 carbon atoms is of about 0.5% to about 7% by weight, based on the total weight of the composition. In some embodiments, the amount of the alkyl naphthalene sulfonate wherein the alkyl contains between about 1 to about 16 carbon atoms is of about 1% to about 5% by weight, based on the total weight of the composition. In some embodiments, the amount of the alkyl naphthalene sulfonate is of about 1% to about 3% by weight, based on the total weight of the composition. In some embodiments, the amount of the alkyl naphthalene sulfonate wherein the alkyl contains between about 1 to about 16 carbon atoms is of about 1% to about 2% by weight, based on the total weight of the composition.

In some embodiments, the amount of the alkyl naphthalene sulfonate wherein the alkyl contains between about 10 to about 13 carbon atoms is of about 0.5% to about 7% by weight, based on the total weight of the composition. In some embodiments, the amount of the alkyl naphthalene sulfonate wherein the alkyl contains between about 10 to about 13 carbon atoms is of about 1% to about 5% by weight, based on the total weight of the composition. In some embodiments, the amount of the alkyl naphthalene sulfonate wherein the alkyl contains between about 10 to about 13 carbon atoms is of about 1% to about 3% by weight, based on the total weight of the composition. In some embodiments, the amount of the alkyl naphthalene sulfonate wherein the alkyl contains between about 10 to about 13 carbon atoms is of about 1% to about 2% by weight, based on the total weight of the composition.

In some embodiments, the amount of sodium n-butyl naphthalene sulfonate is of about 0.5% to about 7% by weight, based on the total weight of the composition. In some embodiments, the amount of sodium n-butyl naphthalene sulfonate is of about 1% to about 5% by weight, based on the total weight of the composition. In some embodiments, the amount of sodium n-butyl naphthalene sulfonate is of about 1% to about 3% by weight, based on the total weight of the composition. In some embodiments, the amount of sodium n-butyl naphthalene sulfonate is of about 1% to about 2% by weight, based on the total weight of the composition.

In some embodiments, the amount of sodium di-isobutyl naphthalene sulfonate is of about 0.5% to about 7% by weight, based on the total weight of the composition. In some embodiments, the amount of sodium di-isobutyl naphthalene sulfonate is of about 1% to about 5% by weight, based on the total weight of the composition. In some embodiments, the amount of sodium di-isobutyl naphthalene sulfonate is of about 1% to about 3% by weight, based on the total weight of the composition. In some embodiments, the amount of sodium di-isobutyl naphthalene sulfonate is of about 1% to about 2% by weight, based on the total weight of the composition.

In some embodiments, the amount of sodium isopropyl naphthalene sulfonate is of about 0.5% to about 7% by weight, based on the total weight of the composition. In some embodiments, the amount of sodium isopropyl naphthalene sulfonate is of about 1% to about 5% by weight, based on the total weight of the composition. In some embodiments, the amount of sodium isopropyl naphthalene sulfonate is of about 1% to about 3% by weight, based on the total weight of the composition. In some embodiments, the amount of sodium isopropyl naphthalene sulfonate is of about 1% to about 2% by weight, based on the total weight of the composition.

In some embodiments, the amount of sodium isopropyl naphthalene sulfonate is of about 0.5% to about 7% by weight, based on the total weight of the composition. In some embodiments, the amount of sodium isopropyl naphthalene sulfonate is of about 1% to about 5% by weight, based on the total weight of the composition. In some embodiments, the amount of sodium isopropyl naphthalene sulfonate is of about 1% to about 3% by weight, based on the total weight of the composition. In some embodiments, the amount of sodium isopropyl naphthalene sulfonate is of about 1% to about 2% by weight, based on the total weight of the composition.

In some embodiments, the amount of the alkylbenzene sulfonate. is of about 0.5% to about 7% by weight, based on the total weight of the composition. In some embodiments, the amount of the alkylbenzene sulfonate is of about 1% to about 5% by weight, based on the total weight of the composition. In some embodiments, the amount of the alkylbenzene sulfonate is of about 1% to about 3% by weight, based on the total weight of the composition. In some embodiments, the amount of the alkylbenzene sulfonate is of about 1% to about 2% by weight, based on the total weight of the composition.

In some embodiments, the amount of the alkylbenzene sulfonate wherein the alkyl contains between about 8 to about 20 carbon atoms is of about 0.5% to about 7% by weight, based on the total weight of the composition. In some embodiments, the amount of the alkylbenzene sulfonate wherein the alkyl contains between about 8 to about 20 carbon atoms is of about 1% to about 5% by weight, based on the total weight of the composition. In some embodiments, the amount of the alkylbenzene sulfonate wherein the alkyl contains between about 8 to about 20 carbon atoms is of about 1% to about 3% by weight, based on the total weight of the composition. In some embodiments, the amount of the alkylbenzene sulfonate wherein the alkyl contains between about 8 to about 20 carbon atoms is of about 1% to about 2% by weight, based on the total weight of the composition.

In some embodiments, the amount of the alkylbenzene sulfonate wherein the alkyl contains between about 10 to about 16 carbon atoms is of about 0.5% to about 7% by weight, based on the total weight of the composition. In some embodiments, the amount of the alkylbenzene sulfonate wherein the alkyl contains between about 10 to about 16 carbon atoms is of about 1% to about 5% by weight, based on the total weight of the composition. In some embodiments, the amount of the alkylbenzene sulfonate wherein the alkyl contains between about 10 to about 16 carbon atoms is of about 1% to about 3% by weight, based on the total weight of the composition. In some embodiments, the amount of the alkylbenzene sulfonate wherein the alkyl contains between about 10 to about 16 carbon atoms is of about 1% to about 2% by weight, based on the total weight of the composition.

In some embodiments, the amount of the alkylbenzene sulfonate wherein the alkyl contains between about 10 to about 13 carbon atoms is of about 0.5% to about 7% by weight, based on the total weight of the composition. In some embodiments, the amount of the alkylbenzene sulfonate wherein the alkyl contains between about 10 to about 13 carbon atoms is of about 1% to about 5% by weight, based on the total weight of the composition. In some embodiments, the amount of the alkylbenzene sulfonate wherein the alkyl contains between about 10 to about 13 carbon atoms is of about 1% to about 3% by weight, based on the total weight of the composition. In some embodiments, the amount of the alkylbenzene sulfonate wherein the alkyl contains between about 10 to about 13 carbon atoms is of about 1% to about 2% by weight, based on the total weight of the composition.

In some embodiments, the amount of dodecylbenzene sulfonic acid sodium salt is of about 0.5% to about 7% by weight, based on the total weight of the composition. In some embodiments, the amount of dodecylbenzene sulfonic acid sodium salt is of about 1% to about 5% by weight, based on the total weight of the composition. In some embodiments, the amount of dodecylbenzene sulfonic acid sodium salt is of about 1% to about 3% by weight, based on the total weight of the composition. In some embodiments, the amount of dodecylbenzene sulfonic acid sodium salt is of about 1% to about 2% by weight, based on the total weight of the composition.

In some embodiments, the amount of tridecylbenzene sulfonic acid sodium salt is of about 0.5% to about 7% by weight, based on the total weight of the composition. In some embodiments, the amount of tridecylbenzene sulfonic acid sodium salt is of about 1% to about 5% by weight, based on the total weight of the composition. In some embodiments, the amount of tridecylbenzene sulfonic acid sodium salt is of about 1% to about 3% by weight, based on the total weight of the composition. In some embodiments, the amount of tridecylbenzene sulfonic acid sodium salt is of about 1% to about 2% by weight, based on the total weight of the composition.

In some embodiments, the amount of the sodium salt of (C10-16)alkylbenzenesulfonate is of about 0.5% to about 7% by weight, based on the total weight of the composition. In some embodiments, the amount of the sodium salt of (C10-16)alkylbenzenesulfonate is of about 1% to about 5% by weight, based on the total weight of the composition. In some embodiments, the amount of the sodium salt of (C10-16)alkylbenzenesulfonate is of about 1% to about 3% by weight, based on the total weight of the composition. In some embodiments, the amount of the sodium salt of (C10-16)alkylbenzenesulfonate is of about 1% to about 2% by weight, based on the total weight of the composition.

In some embodiments, the amount of the sodium salt of (C10-13)alkylbenzenesulfonate is of about 0.5% to about 7% by weight, based on the total weight of the composition. In some embodiments, the amount of the sodium salt of (C10-13)alkylbenzenesulfonate is of about 1% to about 5% by weight, based on the total weight of the composition. In some embodiments, the amount of the sodium salt of (C10-13)alkylbenzenesulfonate is of about 1% to about 3% by weight, based on the total weight of the composition. In some embodiments, the amount of the sodium salt of (C10-13)alkylbenzenesulfonate is of about 1% to about 2% by weight, based on the total weight of the composition.

In some embodiments, the amount of the anionic alkoxylated polyarylphenol is of about 0.5% to about 7% by weight, based on the total weight of the composition. In some embodiments, the amount of the anionic alkoxylated polyarylphenol is of about 1% to about 5% by weight, based on the total weight of the composition. In some embodiments, the amount of the anionic alkoxylated polyarylphenol is of about 1% to about 3% by weight, based on the total weight of the composition. In some embodiments, the amount of the anionic alkoxylated polyarylphenol is of about 1% to about 2% by weight, based on the total weight of the composition.

In some embodiments, the amount of the alkoxylayed tristyrylphenol phosphate is of about 0.5% to about 7% by weight, based on the total weight of the composition. In some embodiments, the amount of the alkoxylayed tristyrylphenol phosphate is of about 1% to about 5% by weight, based on the total weight of the composition. In some embodiments, the amount of the alkoxylayed tristyrylphenol phosphate is of about 1% to about 3% by weight, based on the total weight of the composition. In some embodiments, the amount of the alkoxylayed tristyrylphenol phosphate is of about 1% to about 2% by weight, based on the total weight of the composition.

In some embodiments, the amount of 2,4,6-Tris(1-phenylethyl)phenol polyoxyethylenated phosphate is of about 1% to about 7% by weight, based on the total weight of the composition. In some embodiments, the amount of 2,4,6-Tris(1-phenylethyl)phenol polyoxyethylenated phosphate is of about 1% to about 5% by weight, based on the total weight of the composition. In some embodiments, the amount of 2,4,6-Tris(1-phenylethyl)phenol polyoxyethylenated phosphate is of about 1% to about 3% by weight, based on the total weight of the composition. In some embodiments, the amount of 2,4,6-Tris(1-phenylethyl)phenol polyoxyethylenated phosphate is of about 1% to about 2% by weight, based on the total weight of the composition.

In some embodiments, the amount of 2,4,6-Tris(1-phenylethyl)phenol polyoxyethylenated phosphate with about 16 unites of ethylene oxide is of about 1% to about 7% by weight, based on the total weight of the composition. In some embodiments, the amount 2,4,6-Tris(1-phenylethyl)phenol polyoxyethylenated phosphate with about 16 unites of ethylene oxide is of about 1% to about 5% by weight, based on the total weight of the composition. In some embodiments, the amount of 2,4,6-Tris(1-phenylethyl)phenol polyoxyethylenated phosphate with about 16 unites of ethylene oxide is of about 1% to about 3% by weight, based on the total weight of the composition. In some embodiments, the amount of 2,4,6-Tris(1-phenylethyl)phenol polyoxyethylenated phosphate with about 16 unites of ethylene oxide is of about 1% to about 2% by weight, based on the total weight of the composition.

In some embodiments, the amount of 2,4,6-Tris(1-phenylethyl)phenol polyoxyethylenated phosphate with number of ethylene oxide unites of about 16 to about 54 is of about 1% to about 7% by weight, based on the total weight of the composition. In some embodiments, the amount 2,4,6-Tris(1-phenylethyl)phenol polyoxyethylenated phosphate with number of ethylene oxide unites of about 16 to about 54 is of about 1% to about 5% by weight, based on the total weight of the composition. In some embodiments, the amount of 2,4,6-Tris(1-phenylethyl)phenol polyoxyethylenated phosphate with number of ethylene oxide unites of about 16 to about 54 is of about 1% to about 3% by weight, based on the total weight of the composition. In some embodiments, the amount of 2,4,6-Tris(1-phenylethyl)phenol polyoxyethylenated phosphate with number of ethylene oxide unites of about 16 to about 54 is of about 1% to about 2% by weight, based on the total weight of the composition.

In some embodiments, the amount of 2,4,6-Tris(1-phenylethyl)phenol polyoxyethylenated phosphate with number of ethylene oxide unites of about 16 is of about 1% to about 7% by weight, based on the total weight of the composition. In some embodiments, the amount 2,4,6-Tris(1-phenylethyl)phenol polyoxyethylenated phosphate with number of ethylene oxide unites of about 16 is of about 1% to about 5% by weight, based on the total weight of the composition. In some embodiments, the amount of 2,4,6-Tris(1-phenylethyl)phenol polyoxyethylenated phosphate with number of ethylene oxide unites of about 16 is of about 1% to about 3% by weight, based on the total weight of the composition. In some embodiments, the amount of 2,4,6-Tris(1-phenylethyl)phenol polyoxyethylenated phosphate with number of ethylene oxide unites of about 16 is of about 1% to about 2% by weight, based on the total weight of the composition.

In some embodiments, the amount of polysiloxane is of about 0.05% to about 0.5% by weight, based on the total weight of the composition. In some embodiments, the amount of polysiloxane is of about 0.1% to about 0.5% by weight, based on the total weight of the composition.

In some embodiments, the amount of polyether modified trisiloxane is of about 0.05% to about 0.5% by weight, based on the total weight of the composition. In some embodiments, the amount of polyether modified trisiloxane is of about 0.1% to about 0.5% by weight, based on the total weight of the composition.

In some embodiments, the amount of 3-[methyl-bis(trimethylsilyloxy)silyl]propan-1-ol is of about 0.05% to about 0.5% by weight, based on the total weight of the composition. In some embodiments, the amount of 3-[methyl-bis(trimethylsilyloxy)silyl]propan-1-ol is of about 0.1% to about 0.5% by weight, based on the total weight of the composition.

In some embodiments, the amount of the surfactant is of about 0.5% to about 5% by weight, based on the total weight of the composition. In some embodiments, the amount of the additional surfactant is of about 0.5% to about 3% by weight, based on the total weight of the composition.

In some embodiments, the amount of the surfactant is of about 0.5% to about 5% by weight, based on the total weight of the composition. In some embodiments, the amount of the surfactant is of about 0.5% to about 3% by weight, based on the total weight of the composition.

In some embodiments, the amount of sodium dioctyl sulphosuccinate is of about 0.5% to about 5% by weight, based on the total weight of the composition. In some embodiments, the amount of sodium dioctyl sulphosuccinate is of about 0.5% to about 3% by weight, based on the total weight of the composition.

In some embodiments, the amount of polysorbate is of about 0.5% to about 5% by weight, based on the total weight of the composition. In some embodiments, the amount of polysorbate is of about 0.5% to about 3% by weight, based on the total weight of the composition.

In some embodiments, the amount of polyoxyethylene sorbitan monolaurate is of about 0.5% to about 5% by weight, based on the total weight of the composition. In some embodiments, the amount of polyoxyethylene sorbitan monolaurate is of about 0.5% to about 3% by weight, based on the total weight of the composition.

In some embodiments, the amount of secondary alcohol ethoxylate is of about 0.5% to about 5% by weight, based on the total weight of the composition. In some embodiments, the amount of secondary alcohol ethoxylate is of about 0.5% to about 3% by weight, based on the total weight of the composition.

In some embodiments, the amount of the C11-C15 secondary alcohol ethoxylate is of about 0.5% to about 5% by weight, based on the total weight of the composition. In some embodiments, the amount of the C11-C15 secondary alcohol ethoxylate is of about 0.5% to about 3% by weight, based on the total weight of the composition.

In some embodiments, the amount of the C12-C14 secondary alcohol ethoxylate is of about 0.5% to about 5% by weight, based on the total weight of the composition. In some embodiments, the amount of the C12-C14 secondary alcohol ethoxylate is of about 0.5% to about 3% by weight, based on the total weight of the composition.

In some embodiments, the C11-C15 secondary alcohol ethoxylate with number of ethylene oxide units of about 3 to about 16 is of about 0.5% to about 5% by weight, based on the total weight of the composition. In some embodiments, the C11-C15 secondary alcohol ethoxylate with number of ethylene oxide units of about 3 to about 12 is of about 0.5% to about 5% by weight, based on the total weight of the composition. In some embodiments, the C11-C15 secondary alcohol ethoxylate with number of ethylene oxide units of about 3 to about 9 is of about 0.5% to about 5% by weight, based on the total weight of the composition. In one embodiment, the C11-C15 secondary alcohol ethoxylate with number of ethylene oxide units of about 9 is of about 0.5% to about 5% by weight, based on the total weight of the composition.

In some embodiments, the C12-C14 secondary alcohol ethoxylate with number of ethylene oxide units of about 3 to about 16 is of about 0.5% to about 5% by weight, based on the total weight of the composition. In some embodiments, the C12-C14 secondary alcohol ethoxylate with number of ethylene oxide units of about 3 to about 12 is of about 0.5% to about 5% by weight, based on the total weight of the composition. In some embodiments, the C12-C14 secondary alcohol ethoxylate with number of ethylene oxide units of about 3 to about 9 is of about 0.5% to about 5% by weight, based on the total weight of the composition. In one embodiment, the C12-C14 secondary alcohol ethoxylate with number of ethylene oxide units of about 9 is of about 0.5% to about 5% by weight, based on the total weight of the composition.

In some embodiments, the amount of water is of about 10% to about 75% by weight, based on the total weight of the composition. In some embodiments, the amount of water is of about 10% to about 70% by weight, based on the total weight of the composition. In some embodiments, the amount of water is of about 30% to about 70% by weight, based on the total weight of the composition. In some embodiments, the amount of water is of about 40% to about 70% by weight, based on the total weight of the composition. In some embodiments, the amount of water is of about 50% to about 70% by weight, based on the total weight of the composition.

In some embodiments, the composition further comprises at least one dispersing agent.

In some embodiments, the dispersing agent is selected from polycarboxylate, acrylic copolymers, nonionic alkoxylated polyarylphenol, naphthalene sulfonate condensate and any combination thereof.

In some embodiments, the amount of the dispersing agent is of about 1% to about 7% by weight, based on the total weight of the composition.

In some embodiments, the composition further comprises at least one adjuvant.

In some embodiments, the agrochemical suspension concentrate composition comprising:
a. from about 1% to about 15% by weight, based on the total weight of the composition of at least one ketoenol insecticide
b. from about 1% to about 10% by weight, based on the total weight of the composition of at least one mitochondrial complex I electron transport inhibitor insecticide
c. a wetting system comprising of:
   1. from about 0.5% to about 7% by weight, based on the total weight of the composition of at least one anionic surfactant selected from alkoxylated polyarylphenol, alcohol ethoxylate and/or propoxylate phosphate ester, sodium alkyl sulfate, sodium alkyl ether sulfate, alkyl naphthalene sulfonate and alkylbenzene sulfonate
   2. from about 0.05% to about 0.5% by weight, based on the total weight of the composition of at least one polysiloxane wherein the ratio of the anionic surfactant to the polysiloxane is from about 0.1:5 to about 5:0.1
   3. from about 0.5% to about 5% by weight, based on the total weight of the composition of at least one additional surfactant; and
d. from about 50% to about 75% by weight, based on the total weight of the composition of water.

In some embodiments, the agrochemical suspension concentrate composition comprising:
a. from about 1% to about 15% by weight, based on the total weight of the composition of at least one ketoenol insecticide
b. from about 1% to about 10% by weight, based on the total weight of the composition of at least one mitochondrial complex I electron transport inhibitor insecticide
c. a wetting system comprising of:
   1. from about 0.5% to about 7% by weight, based on the total weight of the composition of at least one anionic surfactant selected from alkoxylated polyarylphenol, alcohol ethoxylate and/or propoxylate phosphate ester, sodium alkyl sulfate, sodium alkyl ether sulfate, alkyl naphthalene sulfonate and alkylbenzene sulfonate;
   2. from about 0.05% to about 0.5% by weight, based on the total weight of the composition of at least one polysiloxane wherein the ratio of the anionic surfactant to the polysiloxane is from about 0.1:5 to about 5:0.1;
   3. from about 0.5% to about 5% by weight, based on the total weight of the composition of at least one additional surfactant selected from sodium dioctyl sulphosuccinate, polysorbate, secondary alcohol ethoxylate;
   and
d. from about 50% to about 75% by weight, based on the total weight of the composition of water.

In some embodiments, the agrochemical suspension concentrate composition comprising:
a. from about 1% to about 15% by weight, based on the total weight of the composition of at least one ketoenol insecticide
b. from about 1% to about 10% by weight, based on the total weight of the composition of at least one mitochondrial complex I electron transport inhibitor insecticide
c. a wetting system comprising of:
   1. from about 1% to about 5% by weight, based on the total weight of the composition of at least one anionic surfactant selected from alkoxylated polyarylphenol, alcohol ethoxylate and/or propoxylate phosphate ester, sodium alkyl sulfate, sodium alkyl ether sulfate, alkyl naphthalene sulfonate and alkylbenzene sulfonate;
   2. from about 0.1% to about 0.5% by weight, based on the total weight of the composition of at least one polysiloxane wherein the ratio of the anionic surfactant to the polysiloxane is from about 0.1:5 to about 5:0.1;
   3. from about 0.5% to about 3% by weight, based on the total weight of the composition of at least one additional surfactant selected from sodium dioctyl sulphosuccinate, polysorbate, secondary alcohol ethoxylate; and
d. from about 50% to about 75% by weight, based on the total weight of the composition of water.

In some embodiments, agrochemical suspension concentrate composition comprising:
a. spirotetramat
b. fenpyroximate
c. a wetting system comprising of:
   1. at least one anionic surfactant selected from alkoxylated polyarylphenol, alcohol ethoxylate and/or propoxylate phosphate ester, sodium alkyl sulfate, sodium alkyl
   2. at least one polysiloxane, wherein the ratio of at least one anionic surfactant to at least one polysiloxane is from about 0.1:5 to about 5:0.1;
   3. optionally, at least one additional surfactant;
and
d. water.

In some embodiments, agrochemical suspension concentrate composition comprising:
a. spirotetramat
b. fenpyroximate
c. a wetting system comprising of:
   1. at least one anionic surfactant selected from alkoxylated polyarylphenol, alcohol ethoxylate and/or propoxylate phosphate ester, sodium alkyl sulfate, sodium alkyl ether sulfate, alkyl naphthalene sulfonate and alkylbenzene sulfonate;
   2. at least one polysiloxane, wherein the ratio of at least one anionic surfactant to at least one polysiloxane is from about 0.1:5 to about 5:0.1;
   3. at least one additional surfactant selected from sodium dioctyl sulphosuccinate, polysorbate, secondary alcohol ethoxylate;
and
d. water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 1% to about 2% by weight, based on the total weight of the composition of at least one anionic surfactant selected from alkoxylated polyarylphenol, alcohol ethoxylate and/or propoxylate phosphate ester, sodium alkyl sulfate, sodium alkyl ether sulfate, alkyl naphthalene sulfonate and alkylbenzene sulfonate;
   2. from about 0.1% to about 0.5% by weight, based on the total weight of the composition of 3-[methyl-bis(trimethylsilyloxy)silyl]propan-1-ol wherein the ratio of the anionic surfactant to the polysiloxane is from about 0.1:5 to about 5:0.1;
   3. from about 0.5% to about 3% by weight, based on the total weight of the composition of at least one additional surfactant selected from sodium dioctyl sulphosuccinate, polysorbate, secondary alcohol ethoxylate; and
d. from about 50% to about 75% by weight, based on the total weight of the composition of water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 1% to about 2% by weight, based on the total weight of the composition of at least one anionic surfactant selected from alkoxylated polyarylphenol, alcohol ethoxylate and/or propoxylate phosphate ester, sodium alkyl sulfate, sodium alkyl ether sulfate, alkyl naphthalene sulfonate and alkylbenzene sulfonate;
   2. from about 0.1% to about 0.5% by weight, based on the total weight of the composition of 3-[methyl-bis(trimethylsilyloxy)silyl]propan-1-ol wherein the ratio of the anionic surfactant to the polysiloxane is from about 0.1:5 to about 5:0.1;
   3. from about 0.5% to about 3% by weight, based on the total weight of the composition of C12-C14 secondary alcohol ethoxylate with number of ethylene oxide units of about 9; and
d. from about 50% to about 75% by weight, based on the total weight of the composition of water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 1% to about 2% by weight, based on the total weight of the composition of at least one anionic surfactant selected from alkoxylated polyarylphenol, alcohol ethoxylate and/or propoxylate phosphate ester, sodium alkyl sulfate, sodium alkyl ether sulfate, alkyl naphthalene sulfonate and alkylbenzene sulfonate;
   2. from about 0.1% to about 0.5% by weight, based on the total weight of the composition of 3-[methyl-bis(trimethylsilyloxy)silyl]propan-1-ol wherein the ratio of at the anionic surfactant to the polysiloxane is from about 0.1:5 to about 5:0.1;
   3. from about 0.5% to about 3% by weight, based on the total weight of the composition of sodium dioctyl sulphosuccinate; and
d. from about 50% to about 75% by weight, based on the total weight of the composition of water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 1% to about 2% by weight, based on the total weight of the composition of at least one anionic surfactant selected from alkoxylated polyarylphenol, alcohol ethoxylate and/or propoxylate phosphate ester, sodium alkyl sulfate, sodium alkyl
   2. from about 0.1% to about 0.5% by weight, based on the total weight of the composition of 3-[methyl-bis(trimethylsilyloxy)silyl]propan-1-ol wherein the ratio of at the anionic surfactant to the polysiloxane is from about 0.1:5 to about 5:0.1;
   3. from about 0.5% to about 3% by weight, based on the total weight of the composition of polysorbate; and
d. from about 50% to about 75% by weight, based on the total weight of the composition of water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 1% to about 2% by weight, based on the total weight of the composition of at least one anionic surfactant selected from alkoxylated polyarylphenol, alcohol ethoxylate and/or propoxylate phosphate ester, sodium alkyl sulfate, sodium alkyl ether sulfate, alkyl naphthalene sulfonate and alkylbenzene sulfonate;
   2. from about 0.1% to about 0.5% by weight, based on the total weight of the composition of 3-[methyl-bis(trimethylsilyloxy)silyl]propan-1-ol wherein the ratio of the anionic surfactant to the polysiloxane is from about 0.1:5 to about 5:0.1;
   3. from about 0.5% to about 3% by weight, based on the total weight of the composition of polyoxyethylene sorbitan monolaurate; and
d. from about 50% to about 75% by weight, based on the total weight of the composition of water.

In some embodiments, agrochemical suspension concentrate composition comprising:
a. spirotetramat
b. fenpyroximate
c. from about 0.5% to about 7% by weight, based on the total weight of the composition of at least one anionic surfactant selected from alkoxylated polyarylphenol, alcohol ethoxylate and/or propoxylate phosphate ester, sodium alkyl sulfate, sodium alkyl ether sulfate, alkyl naphthalene sulfonate and alkylbenzene sulfonate
d. from about 0.05% to about 0.5% by weight, based on the total weight of the composition of at least one polyether modified trisiloxane wherein the ratio of the anionic surfactant to the polysiloxane is from about 0.1:5 to about 5:0.1;
e. from about 0.5% to about 5% by weight, based on the total weight of the composition of sodium dioctyl sulphosuccinate and/or at least one polyoxyethylenesorbitan monolaurate and
f. water.

The present invention provides an agrochemical suspension concentrate composition comprising:
a. at least one ketoenol insecticide
b. at least one mitochondrial complex I electron transport inhibitor insecticide
c. a wetting system comprising of:
   1. at least one anionic surfactant selected from alkoxylated polyarylphenol, alcohol ethoxylate and or propoxylate phosphate ester, sodium alkyl sulfate, sodium alkyl ether sulfate, alkyl naphthalene sulfonate and alkylbenzene sulfonate
   2. at least one polysiloxane, wherein the ratio of at least one anionic surfactant to at least one polysiloxane is from about 0.1:5 to about 5:0.1;
   3. at least one additional dispersant
and
d. water.

In some embodiments, the ketoenol insecticide is selected from spirotetramat, spidoxamat, spiropidion, spirodiclofen, spiromesifen and any combinations thereof. In one embodiment, the ketoenol insecticide is spirotetramat.

In some embodiments, the amount of the ketoenol insecticide is of about 1% to about 60% by weight, based on the total weight of the composition. In some embodiments, the amount of the ketoenol insecticide is of about 1% to about 30% by weight, based on the total weight of the composition. In some embodiments, the amount of the ketoenol insecticide is of about 1% to about 20% by weight, based on the total weight of the composition. In some embodiments, the amount of the ketoenol insecticide is of about 1% to about 15% by weight, based on the total weight of the composition. In some embodiments, the amount of the ketoenol insecticide is of about 1% to about 10% by weight, based on the total weight of the composition.

In some embodiments, the amount of spirotetramat is of about 1% to about 60% by weight, based on the total weight of the composition. In some embodiments, the amount of spirotetramat is of about 1% to about 30% by weight, based on the total weight of the composition. In some embodiments, the amount of spirotetramat is of about 1% to about 20% by weight, based on the total weight of the composition. In some embodiments, the amount of spirotetramat is of about 1% to about 15% by weight, based on the total weight of the composition. In some embodiments, the amount of spirotetramat is of about 1% to about 10% by weight, based on the total weight of the composition.

In some embodiments, the mitochondrial complex I electron transport inhibitors insecticide is selected from fenazaquin, fenpyroximate, pyridaben, pyrimidifen, tebufenpyrad, tolfenpyrad and any combinations thereof. In one embodiment, the mitochondrial complex I electron transport inhibitors insecticide is fenpyroximate.

In some embodiments, the amount of the mitochondrial complex I electron transport inhibitors insecticide is of about 1% to about 40% by weight, based on the total weight of the composition. In some embodiments, the amount of the mitochondrial complex I electron transport inhibitors insecticide is of about 1% to about 30% by weight, based on the total weight of the composition. In some embodiments, the amount of the mitochondrial complex I electron transport inhibitors insecticide is of about 1% to about 20% by weight, based on the total weight of the composition. In some embodiments, the amount of the mitochondrial complex I electron transport inhibitors insecticide is of about 1% to about 10% by weight, based on the total weight of the composition.

In some embodiments, the amount of fenpyroximate is of about 1% to about 40% by weight, based on the total weight of the composition. In some embodiments, the amount of fenpyroximate is of about 1% to about 30% by weight, based on the total weight of the composition. In some embodiments, the amount of fenpyroximate is of about 1% to about 20% by weight, based on the total weight of the composition. In some embodiments, the amount of fenpyroximate is of about 1% to about 10% by weight, based on the total weight of the composition.

In some embodiments, the at least one anionic surfactant selected from alkoxylated polyarylphenol, alcohol ethoxylate and or propoxylate phosphate ester, sodium alkyl sulfate, sodium alkyl ether sulfate, alkyl naphthalene sulfonate and alkylbenzene sulfonate.

In some embodiments, the anionic surfactant is alcohol ethoxylate and/or propoxylate phosphate ester. In some embodiments, the anionic surfactant is alcohol ethoxylate phosphate ester. In some embodiments, the anionic surfactant is alcohol propoxylate phosphate ester. In some embodiments, the anionic surfactant is a combination of alcohol ethoxylate and alcohol propoxylate phosphate ester.

Non limiting examples for alcohol ethoxylate and/or propoxylate phosphate ester are servoxyl VPTZ 3/100, STEPFAC™ 3675, STEPFAC 8181 PT3K, Lubrhophos LF 800, HOSTAPHAT® 1306 and HORDAPHOS 1306.

In some embodiments, the anionic surfactant is sodium alkyl sulfate. In some embodiments, the anionic surfactant is sodium alkyl sulfate wherein the alkyl contains between about 6 to about 18 carbon atoms. In some embodiments, the anionic surfactant is sodium alkyl sulfate wherein the alkyl contains between about 10 to about 16 carbon atoms. In some embodiments, the anionic surfactant is sodium alkyl sulfate wherein the alkyl contains between about 12 to about 14 carbon atoms. In some embodiments, the anionic surfactant is sodium alkyl sulfate wherein the alkyl contains about 12 carbon atoms. In some embodiments, the anionic surfactant is sodium alkyl sulfate wherein the alkyl contains about 14 carbon atoms.

Non limiting examples for sodium alkyl sulfates are sodium dodecyl sulfate, sodium tetradecyl sulfate and

In some embodiments, the anionic surfactant is sodium alkyl ether sulfate. In some embodiments, the anionic surfactant is sodium alkyl ether sulfate wherein the alkyl contains between about 6 to about 18 carbon atoms. In some embodiments, the anionic surfactant is sodium alkyl ether sulfate wherein the alkyl contains between about 10 to about 16 carbon atoms. In some embodiments, the anionic surfactant is sodium alkyl ether sulfate wherein the alkyl contains between about 12 to about 14 carbon atoms. In some embodiments, the anionic surfactant is sodium alkyl ether sulfate wherein the alkyl contains about 12 carbon atoms. In some embodiments, the anionic surfactant is sodium alkyl ether sulfate wherein the alkyl contains about 14 carbon atoms.

In some embodiments, the anionic surfactant is sodium alkyl ether sulfate wherein the alkyl contains between about 6 to about 18 carbon atoms and the degree of ethoxylation is between about one ethylene oxide group to about twenty ethylene oxide group. In some embodiments, the anionic surfactant is sodium alkyl ether sulfate wherein the alkyl contains between about 10 to about 16 carbon atoms and the degree of ethoxylation is between about one ethylene oxide group to about twenty ethylene oxide group. In some embodiments, the anionic surfactant is sodium alkyl ether sulfate wherein the alkyl contains between about 12 to about 14 carbon atoms and the degree of ethoxylation is between about one ethylene oxide group to about twenty ethylene oxide group. In some embodiments, the anionic surfactant is sodium alkyl ether sulfate wherein the alkyl contains about 12 carbon atoms and the degree of ethoxylation is between about one ethylene oxide group to about twenty ethylene oxide group. In some embodiments, the anionic surfactant is sodium alkyl ether sulfate wherein the alkyl contains about 14 carbon atoms and the degree of ethoxylation is between about one ethylene oxide group to about twenty ethylene oxide group.

In some embodiments, the anionic surfactant is sodium alkyl ether sulfate wherein the alkyl contains between about 6 to about 18 carbon atoms and the degree of ethoxylation is between about three ethylene oxide group to about eighteen ethylene oxide group. In some embodiments, the anionic surfactant is sodium alkyl ether sulfate wherein the alkyl contains between about 10 to about 16 carbon atoms and the degree of ethoxylation is between about three ethylene oxide group to about eighteen ethylene oxide group. In some embodiments, the anionic surfactant is sodium alkyl ether sulfate wherein the alkyl contains between about 12 to about 14 carbon atoms and the degree of ethoxylation is between about three ethylene oxide group to about eighteen ethylene oxide group. In some embodiments, the anionic surfactant is sodium alkyl ether sulfate wherein the alkyl contains about 12 carbon atoms and the degree of ethoxylation is between about three ethylene oxide group to about eighteen ethylene oxide group. In some embodiments, the anionic surfactant is sodium alkyl ether sulfate wherein the alkyl contains about 14 carbon atoms and the degree of ethoxylation is between about three ethylene oxide group to about eighteen ethylene oxide group.

In some embodiments, the anionic surfactant is sodium alkyl ether sulfate wherein the alkyl contains between about 6 to about 18 carbon atoms and the degree of ethoxylation is between about ten ethylene oxide group to about sixteen ethylene oxide group. In some embodiments, the anionic surfactant is sodium alkyl ether sulfate wherein the alkyl contains between about 10 to about 16 carbon atoms and the degree of ethoxylation is between about ten ethylene oxide group to about sixteen ethylene oxide group. In some embodiments, the anionic surfactant is sodium alkyl ether sulfate wherein the alkyl contains between about 12 to about 14 carbon atoms and the degree of ethoxylation is between about ten ethylene oxide group to about sixteen ethylene oxide group. In some embodiments, the anionic surfactant is sodium alkyl ether sulfate wherein the alkyl contains about 12 carbon atoms and the degree of ethoxylation is between about ten ethylene oxide group to about sixteen ethylene oxide group. In some embodiments, the anionic surfactant is sodium alkyl ether sulfate wherein the alkyl contains about 14 carbon atoms and the degree of ethoxylation is between about ten ethylene oxide group to about sixteen ethylene oxide group.

Non limiting examples for sodium alkyl ether sulfate are sodium laureth sulfate including sodium Laureth 2 sulfate, sodium Laureth 3 sulfate, sodium Laureth 5 sulfate, sodium Laureth 10 sulfate, and sodium Laureth 12 sulfate.

In some embodiments, the anionic surfactant is alkyl naphthalene sulfonate. In some embodiments, the anionic surfactant is alkyl naphthalene sulfonate wherein the alkyl contains between about 1 to about 16 carbon atoms. In some embodiments, the anionic surfactant is alkyl naphthalene sulfonate wherein the alkyl contains between about 10 to about 13 carbon atoms.

In some embodiments, the alkyl naphthalene sulfonate is selected from sodium n-butyl naphthalene sulfonate, sodium di-isobutyl naphthalene sulfonate, sodium isopropyl naphthalene sulfonate, sodium isopropyl naphthalene sulfonate and any combination thereof.

In some embodiments, the alkyl naphthalene sulfonate is sodium n-butyl naphthalene sulfonate.

In some embodiments, the alkyl naphthalene sulfonate is sodium di-isobutyl naphthalene sulfonate.

In some embodiments, the alkyl naphthalene sulfonate is sodium isopropyl naphthalene sulfonate.

In some embodiments, the alkyl naphthalene sulfonate is sodium isopropyl naphthalene sulfonate.

Non limiting examples for commercial products of alkyl naphthalene sulfonate include Supragil® WP, Morwet EFW Powder, Morwet DB Powder, Morwet DIBS Powder and Morwet IP Powder.

In some embodiments, the anionic surfactant is alkylbenzene sulfonate. In some embodiments, the anionic surfactant is alkylbenzene sulfonate wherein the alkyl contains between about 8 to about 20 carbon atoms. In some embodiments, the anionic surfactant is alkylbenzene sulfonate wherein the alkyl contains between about 10 to about 16 carbon atoms. In some embodiments, the anionic surfactant is alkylbenzene sulfonate wherein the alkyl contains between about 10 to about 13 carbon atoms.

In some embodiments, the alkylbenzene sulfonate is selected from dodecylbenzene sulfonic acid sodium salt, decylbenzene sulfonic acid sodium salt, tridecylbenzene sulfonic acid sodium salt, undecylbenzene sulfonic acid sodium salt, sodium salt of (C10-16)alkylbenzenesulfonate, sodium salt of (C10-13)alkylbenzenesulfonate, C10-14 alkyl benzene sulfonic acid sodium salt, C10-14 monoalkylbenzene sulfonic acid sodium salt, (C10-13)sec alkyl benzene sulfonic acid sodium salt and any combination thereof.

In some embodiments, the alkylbenzene sulfonate is selected from dodecylbenzene sulfonic acid sodium salt, decylbenzene sulfonic acid sodium salt, tridecylbenzene sulfonic acid sodium salt, sodium salt of (C10-16)alkylbenzenesulfonate, sodium salt of (C10-13)alkylbenzenesulfonate, C10-14 alkyl benzene sulfonic acid sodium salt and any combination thereof.

In some embodiments, the alkylbenzene sulfonate is dodecylbenzene sulfonic acid sodium salt.

In some embodiments, the alkylbenzene sulfonate is decylbenzene sulfonic acid sodium salt.

In some embodiments, the alkylbenzene sulfonate is tridecylbenzene sulfonic acid sodium salt.

In some embodiments, the alkylbenzene sulfonate is sodium salt of (C10-16)alkylbenzenesulfonate.

In some embodiments, the alkylbenzene sulfonate is sodium salt of (C10-13)alkylbenzenesulfonate.

In some embodiments, the alkylbenzene sulfonate is C10-14 alkyl benzene sulfonic acid sodium salt.

Non limiting examples for commercial products of alkylbenzene sulfonate include NINATER 60E, NANSA® EVM 62/H, NANSA® EVM 40/2ND, NANSA® EVM 50/ND, NANSA® EVM 40/2NDL, NANSA® EVM 50/NS, NANSA® EVM 63/B, NANSA® EVM 70/B, NANSA® EVM 62/N, NANSA® EVM 70/13, NANSA® EVM 70/2E, and NANSA® EVM 60/2EG.

In some embodiments, the anionic alkoxylated polyarylphenol is selected from alkoxylated polyarylphenol phosphate, alkoxylated polyarylphenol sulphate and any combination thereof.

In some embodiments, the alkoxylated polyarylphenol phosphate is alkoxylayed tristyrylphenol phosphate.

In some embodiments, the alkoxylayed tristyrylphenol phosphate is 2,4,6-tris(1-phenylethyl)phenol polyoxyethylenated phosphate.

In some embodiments, the number of ethylene oxide unites is of about 16 to about 54. In one embodiment, the number of ethylene oxide unites is of about 16.

In some embodiments, the alkoxylayed tristyrylphenol phosphate is 2,4,6-tris(1-phenylethyl)phenol polyoxyethylenated phosphate with number of ethylene oxide unites of about 16 to about 54.

In some embodiments, the alkoxylayed tristyrylphenol phosphate is 2,4,6-tris(1-phenylethyl)phenol polyoxyethylenated phosphate with number of ethylene oxide unites of about 16.

In some embodiments, the alkoxylayed tristyrylphenol phosphate is 2,4,6-tris(1-phenylethyl)phenol polyoxyethylenated phosphate and the number of ethylene oxide unites is of about 16.

Non limiting examples for alkoxylayed tristyrylphenol phosphate include Soprophor® 3D33, Soprophor® FL, Soprophor® FL-R, Soprophor® SC, Soprophor® FD, Soprophor® FLK, Soprophor® SC3, Soprophor® FLK/70, Soprophor® FL/60 and Soprophor® 3D33 R, Dispersogen TP 160, STEPFAC TSP PE N and SURFOM 1322 SC.

In some embodiments, the alkoxylated polyarylphenol sulphate is selected from alkoxylayed distyrylphenol sulphate, alkoxylayed tristyrylphenol sulphate and any combination thereof.

Non limiting examples for alkoxylated tristyrylphenol sulphate include Soprophor® 4D/384, Tersperse 2218 and LUCRAMUL SPS 16.

In some embodiments, the polysiloxane is a polyether modified trisiloxane.

In some embodiments, the polyether modified trisiloxane is 3-[methyl-bis(trimethylsilyloxy)silyl]propan-1-ol.

Non limiting examples for polysiloxane include BREAK-THRU® S 233, Silwet L-77, Silwet 806 andSilwet 408.

In some embodiments, the ratio of the anionic surfactant to the polysiloxane is from about 0.1:5 to about 5:0.1. In some embodiments, the ratio of the anionic surfactant to the polysiloxane is from about 0.1:2 to about 2:0.1.

In some embodiments, the ratio of the anionic surfactant to the polyether modified trisiloxane is from about 0.1:5 to about 5:0.1. In some embodiments, the ratio of the anionic surfactant to the polyether modified trisiloxane is from about 0.1:2 to about 2:0.1.

In some embodiments, the ratio of the anionic surfactant selected from alkoxylated polyarylphenol, alcohol ethoxylate and/or propoxylate phosphate ester, sodium alkyl sulfate, sodium alkyl ether sulfate, alkyl naphthalene sulfonate and alkylbenzene sulfonate to the polyether modified trisiloxane is from about 0.1:5 to about 5:0.1. In some embodiments, the ratio of the anionic surfactant selected from alkoxylated polyarylphenol, alcohol ethoxylate and/or propoxylate phosphate ester, sodium alkyl sulfate, sodium alkyl ether sulfate, alkyl naphthalene sulfonate and alkylbenzene sulfonate to the polyether modified trisiloxane is from about 0.1:2 to about 2:0.1.

In some embodiments, the ratio of the alkoxylated polyarylphenol to the polyether modified trisiloxane is from about 0.1:5 to about 5:0.1. In some embodiments, the ratio of the alkoxylated polyarylphenol to the polyether modified trisiloxane is from about 0.1:2 to about 2:0.1.

In some embodiments, the ratio of the alcohol ethoxylate and/or propoxylate phosphate ester to the polyether modified trisiloxane is from about 0.1:5 to about 5:0.1. In some embodiments, the ratio of the alcohol ethoxylate and/or propoxylate phosphate ester to the polyether modified trisiloxane is from about 0.1:2 to about 2:0.1.

In some embodiments, the ratio of the alcohol ethoxylate phosphate ester to the polyether modified trisiloxane is from about 0.1:5 to about 5:0.1. In some embodiments, the ratio of the alcohol ethoxylate phosphate ester to the polyether modified trisiloxane is from about 0.1:2 to about 2:0.1.

In some embodiments, the ratio of the sodium alkyl sulfate to the polyether modified trisiloxane is from about 0.1:5 to about 5:0.1. In some embodiments, the ratio of the sodium alkyl sulfate to the polyether modified trisiloxane is from about 0.1:2 to about 2:0.1.

In some embodiments, the ratio of the sodium alkyl ether sulfate to the polyether modified trisiloxane is from about 0.1:5 to about 5:0.1. In some embodiments, the ratio of the sodium alkyl ether sulfate to the polyether modified trisiloxane is from about 0.1:2 to about 2:0.1.

In some embodiments, the ratio of the alkyl naphthalene sulfonate to the polyether modified trisiloxane is from about 0.1:5 to about 5:0.1. In some embodiments, the ratio of the alkyl naphthalene sulfonate to the polyether modified trisiloxane is from about 0.1:2 to about 2:0.1.

In some embodiments, the ratio of the alkylbenzene sulfonate to the polyether modified trisiloxane is from about 0.1:5 to about 5:0.1. In some embodiments, the ratio of the alkylbenzene sulfonate to the polyether modified trisiloxane is from about 0.1:2 to about 2:0.1.

In some embodiments, suitable surfactants are all substances that can enhance the wetting properties of the composition.

In certain embodiments which are not limiting, the surfactant can reduce the surface tension of water, increase the spreading abilities of a liquid, provide good absorption and smooth entrance of the active ingredients into the water.

In some embodiments, the at least one dispersant is selected from polycarboxylate, acrylic copolymers, nonionic alkoxylated polyarylphenol, naphthalene sulfonate condensate and any combination thereof.

In some embodiments, the nonionic alkoxylated polyarylphenol is selected from tristyrylphenol ethoxylates.

In some embodiments, the acrylic copolymer is a polymethyl methacrylate-polyethylene oxide graft copolymer.

In some embodiments, the amount of the dispersant is of about 0.5% to about 7% by weight, based on the total weight of the composition. In some embodiments, the amount of the dispersant is of about 0.5% to about 5% by weight, based on the total weight of the composition, the amount of the dispersant is of about 0.5% to about 3% by weight, based on the total weight of the composition. the amount of the dispersant is of about 1% to about 3% by weight, based on the total weight of the composition.

In some embodiments, the amount of the tristyrylphenol ethoxylate is of about 0.5% to about 7% by weight, based on the total weight of the composition. In some embodiments, the amount of the tristyrylphenol ethoxylate is of about 0.5% to about 5% by weight, based on the total weight of the composition, the amount of the tristyrylphenol ethoxylate is of about 0.5% to about 3% by weight, based on the total weight of the composition, the amount of the tristyrylphenol ethoxylate is of about 1% to about 3% by weight, based on the total weight of the composition.

In some embodiments, the amount of the sodium alkyl sulfate wherein the alkyl contains between about 6 to about 18 carbon atoms is of about 0.5% to about 7% by weight, based on the total weight of the composition. In some embodiments, the amount of the sodium alkyl sulfate wherein the alkyl contains between about 6 to about 18 carbon atoms is of about 1% to about 5% by weight, based on the total weight of the composition. In some embodiments, the amount of the sodium alkyl sulfate wherein the alkyl contains between about 6 to about 18 carbon atoms is of about 1% to about 3% by weight, based on the total weight of the composition. In some embodiments, the amount of the sodium alkyl sulfate wherein the alkyl contains between about 6 to about 18 carbon atoms is of about 1% to about 2% by weight, based on the total weight of the composition.

In some embodiments, the amount of the sodium alkyl sulfate wherein the alkyl contains between about 10 to about 16 carbon atoms is of about 0.5% to about 7% by weight, based on the total weight of the composition. In some embodiments, the amount of the sodium alkyl sulfate wherein the alkyl contains between about 10 to about 16 carbon atoms is of about 1% to about 5% by weight, based on the total weight of the composition. In some embodiments, the amount of the sodium alkyl sulfate wherein the alkyl contains between about 10 to about 16 carbon atoms is of about 1% to about 3% by weight, based on the total weight of the composition. In some embodiments, the amount of the sodium alkyl sulfate wherein the alkyl contains between about 10 to about 16 carbon atoms is of about 1% to about 2% by weight, based on the total weight of the composition.

In some embodiments, the amount of the sodium alkyl sulfate wherein the alkyl contains between about 12 to about 14 carbon atoms is of about 0.5% to about 7% by weight, based on the total weight of the composition. In some embodiments, the amount of the sodium alkyl sulfate wherein the alkyl contains between about 12 to about 14 carbon atoms is of about 1% to about 5% by weight, based on the total weight of the composition. In some embodiments, the amount of the sodium alkyl sulfate wherein the alkyl contains between about 12 to about 14 carbon atoms is of about 1% to about 3% by weight, based on the total weight of the composition. In some embodiments, the amount of the sodium alkyl sulfate wherein the alkyl contains between about 12 to about 14 carbon atoms is of about 1% to about 2% by weight, based on the total weight of the composition.

In some embodiments, the amount of the odium alkyl sulfate wherein the alkyl contains about 12 carbon atoms is of about 0.5% to about 7% by weight, based on the total weight of the composition. In some embodiments, the amount of the sodium alkyl sulfate wherein the alkyl contains about 12 carbon atoms is of about 1% to about 5% by weight, based on the total weight of the composition. In some embodiments, the amount of the sodium alkyl sulfate wherein the alkyl contains about 12 carbon atoms is of about 1% to about 3% by weight, based on the total weight of the composition. In some embodiments, the amount of the sodium alkyl sulfate wherein the alkyl contains about 12 carbon atoms is of about 1% to about 2% by weight, based on the total weight of the composition.

In some embodiments, the amount of the sodium alkyl sulfate wherein the alkyl contains about 14 carbon atoms is of about 0.5% to about 7% by weight, based on the total weight of the composition. In some embodiments, the amount of the sodium alkyl sulfate wherein the alkyl contains about 14 carbon atoms is of about 1% to about 5% by weight, based on the total weight of the composition. In some embodiments, the amount of the sodium alkyl sulfate wherein the alkyl contains about 14 carbon atoms is of about 1% to about 3% by weight, based on the total weight of the composition. In some embodiments, the amount of the sodium alkyl sulfate wherein the alkyl contains about 14 carbon atoms is of about 1% to about 2% by weight, based on the total weight of the composition.

In some embodiments, the amount of the sodium alkyl ether sulfate is of about 0.5% to about 7% by weight, based on the total weight of the composition. In some embodiments, the amount of the sodium alkyl ether sulfate is of about 1% to about 5% by weight, based on the total weight of the composition. In some embodiments, the amount of the sodium alkyl ether sulfate is of about 1% to about 3% by weight, based on the total weight of the composition. In some embodiments, the amount of the sodium alkyl ether sulfate is of about 1% to about 2% by weight, based on the total weight of the composition.

In some embodiments, the amount of the sodium alkyl ether sulfate wherein the alkyl contains between about 6 to about 18 carbon atoms is of about 0.5% to about 7% by weight, based on the total weight of the composition. In some embodiments, the amount of the sodium alkyl ether sulfate wherein the alkyl contains between about 6 to about 18 carbon atoms is of about 1% to about 5% by weight, based on the total weight of the composition. In some embodiments, the amount of the sodium alkyl ether sulfate wherein the alkyl contains between about 6 to about 18 carbon atoms is of about 1% to about 3% by weight, based on the total weight of the composition. In some embodiments, the amount of the sodium alkyl ether sulfate wherein the alkyl contains between about 6 to about 18 carbon atoms is of about 1% to about 2% by weight, based on the total weight of the composition.

In some embodiments, the amount of the sodium alkyl ether sulfate wherein the alkyl contains between about 10 to about 16 carbon atoms is of about 0.5% to about 7% by weight, based on the total weight of the composition. In some embodiments, the amount of the sodium alkyl ether sulfate wherein the alkyl contains between about 10 to about 16 carbon atoms is of about 1% to about 5% by weight, based on the total weight of the composition. In some embodiments, the amount of the sodium alkyl ether sulfate wherein the alkyl contains between about 10 to about 16 carbon atoms is of about 1% to about 3% by weight, based on the total weight of the composition. In some embodiments, the amount of the sodium alkyl ether sulfate wherein the alkyl contains between about 10 to about 16 carbon atoms is of about 1% to about 2% by weight, based on the total weight of the composition.

In some embodiments, the amount of the sodium alkyl ether sulfate wherein the alkyl contains between about 12 to about 14 carbon atoms is of about 0.5% to about 7% by weight, based on the total weight of the composition. In some embodiments, the amount of the sodium alkyl ether sulfate wherein the alkyl contains between about 12 to about 14 carbon atoms is of about 1% to about 5% by weight, based on the total weight of the composition. In some embodiments, the amount of the sodium alkyl ether sulfate wherein the alkyl contains between about 12 to about 14 carbon atoms is of about 1% to about 3% by weight, based on the total weight of the composition. In some embodiments, the amount of the sodium alkyl ether sulfate wherein the alkyl contains between about 12 to about 14 carbon atoms is of about 1% to about 2% by weight, based on the total weight of the composition.

In some embodiments, the amount of the sodium alkyl ether sulfate wherein the alkyl contains about 12 carbon atoms is of about 0.5% to about 7% by weight, based on the total weight of the composition. In some embodiments, the amount of the sodium alkyl ether sulfate wherein the alkyl contains about 12 carbon atoms is of about 1% to about 5% by weight, based on the total weight of the composition. In some embodiments, the amount of the sodium alkyl ether sulfate wherein the alkyl contains about 12 carbon atoms is of about 1% to about 3% by weight, based on the total weight of the composition. In some embodiments, the amount of the sodium alkyl ether sulfate wherein the alkyl contains about 12 carbon atoms is of about 1% to about 2% by weight, based on the total weight of the composition.

In some embodiments, the amount of the sodium alkyl ether sulfate wherein the alkyl contains about 14 carbon atoms is of about 0.5% to about 7% by weight, based on the total weight of the composition. In some embodiments, the amount of the sodium alkyl ether sulfate wherein the alkyl contains about 14 carbon atoms is of about 1% to about 5% by weight, based on the total weight of the composition. In some embodiments, the amount of the sodium alkyl ether sulfate wherein the alkyl contains about 14 carbon atoms is of about 1% to about 3% by weight, based on the total weight of the composition. In some embodiments, the amount of the sodium alkyl ether sulfate wherein the alkyl contains about 14 carbon atoms is of about 1% to about 2% by weight, based on the total weight of the composition.

In some embodiments, the amount of sodium laureth sulfate is of about 0.5% to about 7% by weight, based on the total weight of the composition. In some embodiments, the amount of sodium laureth sulfate is of about 1% to about 5% by weight, based on the total weight of the composition. In some embodiments, the amount of sodium laureth sulfate is of about 1% to about 3% by weight, based on the total weight of the composition. In some embodiments, the amount of sodium laureth sulfate is of about 1% to about 2% by weight, based on the total weight of the composition.

In some embodiments, the amount of the alkyl naphthalene sulfonate is of about 0.5% to about 7% by weight, based on the total weight of the composition. In some embodiments, the amount of the alkyl naphthalene sulfonate is of about 1% to about 5% by weight, based on the total weight of the composition. In some embodiments, the amount of the alkyl naphthalene sulfonate is of about 1% to about 3% by weight, based on the total weight of the composition. In some embodiments, the amount of the alkyl naphthalene sulfonate is of about 1% to about 2% by weight, based on the total weight of the composition.

In some embodiments, the amount of the alkyl naphthalene sulfonate wherein the alkyl contains between about 1 to about 16 carbon atoms is of about 0.5% to about 7% by weight, based on the total weight of the composition. In some embodiments, the amount of the alkyl naphthalene sulfonate wherein the alkyl contains between about 1 to about 16 carbon atoms is of about 1% to about 5% by weight, based on the total weight of the composition. In some embodiments, the amount of the alkyl naphthalene sulfonate is of about 1% to about 3% by weight, based on the total weight of the composition. In some embodiments, the amount of the alkyl naphthalene sulfonate wherein the alkyl contains between about 1 to about 16 carbon atoms is of about 1% to about 2% by weight, based on the total weight of the composition.

In some embodiments, the amount of the alkyl naphthalene sulfonate wherein the alkyl contains between about 10 to about 13 carbon atoms is of about 0.5% to about 7% by weight, based on the total weight of the composition. In some embodiments, the amount of the alkyl naphthalene sulfonate wherein the alkyl contains between about 10 to about 13 carbon atoms is of about 1% to about 5% by weight, based on the total weight of the composition. In some embodiments, the amount of the alkyl naphthalene sulfonate wherein the alkyl contains between about 10 to about 13 carbon atoms is of about 1% to about 3% by weight, based on the total weight of the composition. In some embodiments, the amount of the alkyl naphthalene sulfonate wherein the alkyl contains between about 10 to about 13 carbon atoms is of about 1% to about 2% by weight, based on the total weight of the composition.

In some embodiments, the amount of sodium n-butyl naphthalene sulfonate is of about 0.5% to about 7% by weight, based on the total weight of the composition. In some embodiments, the amount of sodium n-butyl naphthalene sulfonate is of about 1% to about 5% by weight, based on the total weight of the composition. In some embodiments, the amount of sodium n-butyl naphthalene sulfonate is of about 1% to about 3% by weight, based on the total weight of the composition. In some embodiments, the amount of sodium n-butyl naphthalene sulfonate is of about 1% to about 2% by weight, based on the total weight of the composition.

In some embodiments, the amount of sodium di-isobutyl naphthalene sulfonate is of about 0.5% to about 7% by weight, based on the total weight of the composition. In some embodiments, the amount of sodium di-isobutyl naphthalene sulfonate is of about 1% to about 5% by weight, based on the total weight of the composition. In some embodiments, the amount of sodium di-isobutyl naphthalene sulfonate is of about 1% to about 3% by weight, based on the total weight of the composition. In some embodiments, the amount of sodium di-isobutyl naphthalene sulfonate is of about 1% to about 2% by weight, based on the total weight of the composition.

In some embodiments, the amount of sodium isopropyl naphthalene sulfonate is of about 0.5% to about 7% by weight, based on the total weight of the composition. In some embodiments, the amount of sodium isopropyl naphthalene sulfonate is of about 1% to about 5% by weight, based on the total weight of the composition. In some embodiments, the amount of sodium isopropyl naphthalene sulfonate is of about 1% to about 3% by weight, based on the total weight of the composition. In some embodiments, the amount of sodium isopropyl naphthalene sulfonate is of about 1% to about 2% by weight, based on the total weight of the composition.

In some embodiments, the amount of sodium isopropyl naphthalene sulfonate is of about 0.5% to about 7% by weight, based on the total weight of the composition. In some embodiments, the amount of sodium isopropyl naphthalene sulfonate is of about 1% to about 5% by weight, based on the total weight of the composition. In some embodiments, the amount of sodium isopropyl naphthalene sulfonate is of about 1% to about 3% by weight, based on the total weight of the composition. In some embodiments, the amount of sodium isopropyl naphthalene sulfonate is of about 1% to about 2% by weight, based on the total weight of the composition.

In some embodiments, the amount of the alkylbenzene sulfonate. is of about 0.5% to about 7% by weight, based on the total weight of the composition. In some embodiments, the amount of the alkylbenzene sulfonate is of about 1% to about 5% by weight, based on the total weight of the composition. In some embodiments, the amount of the alkylbenzene sulfonate is of about 1% to about 3% by weight, based on the total weight of the composition. In some embodiments, the amount of the alkylbenzene sulfonate is of about 1% to about 2% by weight, based on the total weight of the composition.

In some embodiments, the amount of the alkylbenzene sulfonate wherein the alkyl contains between about 8 to about 20 carbon atoms is of about 0.5% to about 7% by weight, based on the total weight of the composition. In some embodiments, the amount of the alkylbenzene sulfonate wherein the alkyl contains between about 8 to about 20 carbon atoms is of about 1% to about 5% by weight, based on the total weight of the composition. In some embodiments, the amount of the alkylbenzene sulfonate wherein the alkyl contains between about 8 to about 20 carbon atoms is of about 1% to about 3% by weight, based on the total weight of the composition. In some embodiments, the amount of the alkylbenzene sulfonate wherein the alkyl contains between about 8 to about 20 carbon atoms is of about 1% to about 2% by weight, based on the total weight of the composition.

In some embodiments, the amount of the alkylbenzene sulfonate wherein the alkyl contains between about 10 to about 16 carbon atoms is of about 0.5% to about 7% by weight, based on the total weight of the composition. In some embodiments, the amount of the alkylbenzene sulfonate wherein the alkyl contains between about 10 to about 16 carbon atoms is of about 1% to about 5% by weight, based on the total weight of the composition. In some embodiments, the amount of the alkylbenzene sulfonate wherein the alkyl contains between about 10 to about 16 carbon atoms is of about 1% to about 3% by weight, based on the total weight of the composition. In some embodiments, the amount of the alkylbenzene sulfonate wherein the alkyl contains between about 10 to about 16 carbon atoms is of about 1% to about 2% by weight, based on the total weight of the composition.

In some embodiments, the amount of the alkylbenzene sulfonate wherein the alkyl contains between about 10 to about 13 carbon atoms is of about 0.5% to about 7% by weight, based on the total weight of the composition. In some embodiments, the amount of the alkylbenzene sulfonate wherein the alkyl contains between about 10 to about 13 carbon atoms is of about 1% to about 5% by weight, based on the total weight of the composition. In some embodiments, the amount of the alkylbenzene sulfonate wherein the alkyl contains between about 10 to about 13 carbon atoms is of about 1% to about 3% by weight, based on the total weight of the composition. In some embodiments, the amount of the alkylbenzene sulfonate wherein the alkyl contains between about 10 to about 13 carbon atoms is of about 1% to about 2% by weight, based on the total weight of the composition.

In some embodiments, the amount of dodecylbenzene sulfonic acid sodium salt is of about 0.5% to about 7% by weight, based on the total weight of the composition. In some embodiments, the amount of dodecylbenzene sulfonic acid sodium salt is of about 1% to about 5% by weight, based on the total weight of the composition. In some embodiments, the amount of dodecylbenzene sulfonic acid sodium salt is of about 1% to about 3% by weight, based on the total weight of the composition. In some embodiments, the amount of dodecylbenzene sulfonic acid sodium salt is of about 1% to about 2% by weight, based on the total weight of the composition.

In some embodiments, the amount of tridecylbenzene sulfonic acid sodium salt is of about 0.5% to about 7% by weight, based on the total weight of the composition. In some embodiments, the amount of tridecylbenzene sulfonic acid sodium salt is of about 1% to about 5% by weight, based on the total weight of the composition. In some embodiments, the amount of tridecylbenzene sulfonic acid sodium salt is of about 1% to about 3% by weight, based on the total weight of the composition. In some embodiments, the amount of tridecylbenzene sulfonic acid sodium salt is of about 1% to about 2% by weight, based on the total weight of the composition.

In some embodiments, the amount of the sodium salt of (C10-16)alkylbenzenesulfonate is of about 0.5% to about 7% by weight, based on the total weight of the composition. In some embodiments, the amount of the sodium salt of (C10-16)alkylbenzenesulfonate is of about 1% to about 5% by weight, based on the total weight of the composition. In some embodiments, the amount of the sodium salt of (C10-16)alkylbenzenesulfonate is of about 1% to about 3% by weight, based on the total weight of the composition. In some embodiments, the amount of the sodium salt of (C10-16)alkylbenzenesulfonate is of about 1% to about 2% by weight, based on the total weight of the composition.

In some embodiments, the amount of the sodium salt of (C10-13)alkylbenzenesulfonate is of about 0.5% to about 7% by weight, based on the total weight of the composition. In some embodiments, the amount of the sodium salt of (C10-13)alkylbenzenesulfonate is of about 1% to about 5% by weight, based on the total weight of the composition. In some embodiments, the amount of the sodium salt of (C10-13)alkylbenzenesulfonate is of about 1% to about 3% by weight, based on the total weight of the composition. In some embodiments, the amount of the sodium salt of (C10-13)alkylbenzenesulfonate is of about 1% to about 2% by weight, based on the total weight of the composition.

In some embodiments, the amount of the anionic alkoxylated polyarylphenol is of about 0.5% to about 7% by weight, based on the total weight of the composition. In some embodiments, the amount of the anionic alkoxylated polyarylphenol is of about 1% to about 5% by weight, based on the total weight of the composition. In some embodiments, the amount of the anionic alkoxylated polyarylphenol is of about 1% to about 3% by weight, based on the total weight of the composition. In some embodiments, the amount of the anionic alkoxylated polyarylphenol is of about 1% to about 2% by weight, based on the total weight of the composition.

In some embodiments, the amount of the alkoxylayed tristyrylphenol phosphate is of about 0.5% to about 7% by weight, based on the total weight of the composition. In some embodiments, the amount of the alkoxylayed tristyrylphenol phosphate is of about 1% to about 5% by weight, based on the total weight of the composition. In some embodiments, the amount of the alkoxylayed tristyrylphenol phosphate is of about 1% to about 3% by weight, based on the total weight of the composition. In some embodiments, the amount of the alkoxylayed tristyrylphenol phosphate is of about 1% to about 2% by weight, based on the total weight of the composition.

In some embodiments, the amount of 2,4,6-Tris(1-phenylethyl)phenol polyoxyethylenated phosphate is of about 1% to about 7% by weight, based on the total weight of the composition. In some embodiments, the amount of 2,4,6-Tris(1-phenylethyl)phenol polyoxyethylenated phosphate is of about 1% to about 5% by weight, based on the total weight of the composition. In some embodiments, the amount of 2,4,6-Tris(1-phenylethyl)phenol polyoxyethylenated phosphate is of about 1% to about 3% by weight, based on the total weight of the composition. In some embodiments, the amount of 2,4,6-Tris(1-phenylethyl)phenol polyoxyethylenated phosphate is of about 1% to about 2% by weight, based on the total weight of the composition.

In some embodiments, the amount of 2,4,6-Tris(1-phenylethyl)phenol polyoxyethylenated phosphate with about 16 unites of ethylene oxide is of about 1% to about 7% by weight, based on the total weight of the composition. In some embodiments, the amount 2,4,6-Tris(1-phenylethyl)phenol polyoxyethylenated phosphate with about 16 unites of ethylene oxide is of about 1% to about 5% by weight, based on the total weight of the composition. In some embodiments, the amount of 2,4,6-Tris(1-phenylethyl)phenol polyoxyethylenated phosphate with about 16 unites of ethylene oxide is of about 1% to about 3% by weight, based on the total weight of the composition. In some embodiments, the amount of 2,4,6-Tris(1-phenylethyl)phenol polyoxyethylenated phosphate with about 16 unites of ethylene oxide is of about 1% to about 2% by weight, based on the total weight of the composition.

In some embodiments, the amount of 2,4,6-Tris(1-phenylethyl)phenol polyoxyethylenated phosphate with number of ethylene oxide unites of about 16 to about 54 is of about 1% to about 7% by weight, based on the total weight of the composition. In some embodiments, the amount 2,4,6-Tris(1-phenylethyl)phenol polyoxyethylenated phosphate with number of ethylene oxide unites of about 16 to about 54 is of about 1% to about 5% by weight, based on the total weight of the composition. In some embodiments, the amount of 2,4,6-Tris(1-phenylethyl)phenol polyoxyethylenated phosphate with number of ethylene oxide unites of about 16 to about 54 is of about 1% to about 3% by weight, based on the total weight of the composition. In some embodiments, the amount of 2,4,6-Tris(1-phenylethyl)phenol polyoxyethylenated phosphate with number of ethylene oxide unites of about 16 to about 54 is of about 1% to about 2% by weight, based on the total weight of the composition.

In some embodiments, the amount of 2,4,6-Tris(1-phenylethyl)phenol polyoxyethylenated phosphate with number of ethylene oxide unites of about 16 is of about 1% to about 7% by weight, based on the total weight of the composition. In some embodiments, the amount 2,4,6-Tris(1-phenylethyl)phenol polyoxyethylenated phosphate with number of ethylene oxide unites of about 16 is of about 1% to about 5% by weight, based on the total weight of the composition. In some embodiments, the amount of 2,4,6-Tris(1-phenylethyl)phenol polyoxyethylenated phosphate with number of ethylene oxide unites of about 16 is of about 1% to about 3% by weight, based on the total weight of the composition. In some embodiments, the amount of 2,4,6-Tris(1-phenylethyl)phenol polyoxyethylenated phosphate with number of ethylene oxide unites of about 16 is of about 1% to about 2% by weight, based on the total weight of the composition.

In some embodiments, the amount of polysiloxane is of about 0.05% to about 0.5% by weight, based on the total weight of the composition. In some embodiments, the amount of polysiloxane is of about 0.1% to about 0.5% by weight, based on the total weight of the composition.

In some embodiments, the amount of polyether modified trisiloxane is of about 0.05% to about 0.5% by weight, based on the total weight of the composition. In some embodiments, the amount of polyether modified trisiloxane is of about 0.1% to about 0.5% by weight, based on the total weight of the composition.

In some embodiments, the amount of 3-[methyl-bis(trimethylsilyloxy)silyl]propan-1-ol is of about 0.05% to about 0.5% by weight, based on the total weight of the composition. In some embodiments, the amount of 3-[methyl-bis(trimethylsilyloxy)silyl]propan-1-ol is of about 0.1% to about 0.5% by weight, based on the total weight of the composition.

In some embodiments, the amount of water is of about 10% to about 75% by weight, based on the total weight of the composition. In some embodiments, the amount of water is of about 10% to about 70% by weight, based on the total weight of the composition. In some embodiments, the amount of water is of about 30% to about 70% by weight, based on the total weight of the composition. In some embodiments, the amount of water is of about 40% to about 70% by weight, based on the total weight of the composition. In some embodiments, the amount of water is of about 50% to about 70% by weight, based on the total weight of the composition.

In some embodiments, the composition further comprises at least one adjuvant.

The present invention provides an agrochemical suspension concentrate composition comprising:
a. at least one ketoenol insecticide
b. at least one mitochondrial complex I electron transport inhibitor insecticide
c. a wetting system comprising of:
   1. at least one anionic alkoxylated polyarylphenol
   2. at least one polysiloxane
   3. at least one additional surfactant
and
d. water.

In some embodiments, the ketoenol insecticide is selected from spirotetramat, spidoxamat, spiropidion, spirodiclofen, spiromesifen and any combinations thereof. In one embodiment, the ketoenol insecticide is spirotetramat.

In some embodiments, the amount of the ketoenol insecticide is of about 1% to about 60% by weight, based on the total weight of the composition. In some embodiments, the amount of the ketoenol insecticide is of about 1% to about 30% by weight, based on the total weight of the composition. In some embodiments, the amount of the ketoenol insecticide is of about 1% to about 20% by weight, based on the total weight of the composition. In some embodiments, the amount of the ketoenol insecticide is of about 1% to about 15% by weight, based on the total weight of the composition. In some embodiments, the amount of the ketoenol insecticide is of about 1% to about 10% by weight, based on the total weight of the composition.

In some embodiments, the amount of spirotetramat is of about 1% to about 60% by weight, based on the total weight of the composition. In some embodiments, the amount of spirotetramat is of about 1% to about 30% by weight, based on the total weight of the composition. In some embodiments, the amount of spirotetramat is of about 1% to about 20% by weight, based on the total weight of the composition. In some embodiments, the amount of spirotetramat is of about 1% to about 15% by weight, based on the total weight of the composition. In some embodiments, the amount of spirotetramat is of about 1% to about 10% by weight, based on the total weight of the composition.

In some embodiments, the mitochondrial complex I electron transport inhibitors insecticide is selected from fenazaquin, fenpyroximate, pyridaben, pyrimidifen, tebufenpyrad, tolfenpyrad and any combinations thereof. In one embodiment, the mitochondrial complex I electron transport inhibitors insecticide is fenpyroximate.

In some embodiments, the amount of the mitochondrial complex I electron transport inhibitors insecticide is of about 1% to about 40% by weight, based on the total weight of the composition. In some embodiments, the amount of the mitochondrial complex I electron transport inhibitors insecticide is of about 1% to about 30% by weight, based on the total weight of the composition. In some embodiments, the amount of the mitochondrial complex I electron transport inhibitors insecticide is of about 1% to about 20% by weight, based on the total weight of the composition. In some embodiments, the amount of the mitochondrial complex I electron transport inhibitors insecticide is of about 1% to about 10% by weight, based on the total weight of the composition.

In some embodiments, the amount of fenpyroximate is of about 1% to about 40% by weight, based on the total weight of the composition. In some embodiments, the amount of fenpyroximate is of about 1% to about 30% by weight, based on the total weight of the composition. In some embodiments, the amount of fenpyroximate is of about 1% to about 20% by weight, based on the total weight of the composition. In some embodiments, the amount of fenpyroximate is of about 1% to about 10% by weight, based on the total weight of the composition.

In some embodiments, the anionic alkoxylated polyarylphenol is selected from alkoxylated polyarylphenol phosphate, alkoxylated polyarylphenol sulphate and any combination thereof.

In some embodiments, the alkoxylated polyarylphenol phosphate is alkoxylayed tristyrylphenol phosphate.

In some embodiments, the alkoxylayed tristyrylphenol phosphate is 2,4,6-tris(1-phenylethyl)phenol polyoxyethylenated phosphate.

In some embodiments, the number of ethylene oxide unites is of about 16 to about 54. In one embodiment, the number of ethylene oxide unites is of about 16.

In some embodiments, the alkoxylayed tristyrylphenol phosphate is 2,4,6-tris(1-phenylethyl)phenol polyoxyethylenated phosphate with number of ethylene oxide unites of about 16 to about 54.

In some embodiments, the alkoxylayed tristyrylphenol phosphate is 2,4,6-tris(1-phenylethyl)phenol polyoxyethylenated phosphate with number of ethylene oxide unites of about 16.

In some embodiments, the alkoxylayed tristyrylphenol phosphate is 2,4,6-tris(1-phenylethyl)phenol polyoxyethylenated phosphate and the number of ethylene oxide unites is of about 16.

Non limiting examples for alkoxylayed tristyrylphenol phosphate include Soprophor® 3D33, Soprophor® FL, Soprophor® FL-R, Soprophor® SC, Soprophor® FD, Soprophor® FLK, Soprophor® SC3, Soprophor® FLK/70, Soprophor® FL/60 and Soprophor® 3D33 R, Dispersogen TP 160, STEPFAC TSP PE N and SURFOM 1322 SC.

In some embodiments, the alkoxylated polyarylphenol sulphate is selected from alkoxylayed distyrylphenol sulphate, alkoxylayed tristyrylphenol sulphate and any combination thereof.

Non limiting examples for alkoxylated tristyrylphenol sulphate include Soprophor® 4D/384, Tersperse 2218 and LUCRAMUL SPS 16.

In some embodiments, the polysiloxane is a polyether modified trisiloxane.

In some embodiments, the polyether modified trisiloxane is 3-[methyl-bis(trimethylsilyloxy)silyl]propan-1-ol.

Non limiting examples for polysiloxane include BREAK-THRU® S 233, Silwet L-77, Silwet 806 andSilwet 408.

In some embodiments, the ratio of the alkoxylated polyarylphenol to the polysiloxane is from about 0.1:5 to about 5:0.1. In some embodiments, the ratio of the alkoxylated polyarylphenol to the polysiloxane is from about 0.1:2 to about 2:0.1.

In some embodiments, the ratio of the alkoxylated polyarylphenol to the polyether modified trisiloxane is from about 0.1:5 to about 5:0.1. In some embodiments, the ratio of the alkoxylated polyarylphenol to the polyether modified trisiloxane is from about 0.1:2 to about 2:0.1.

In some embodiments, the ratio of the alkoxylayed tristyrylphenol phosphate to the polyether modified trisiloxane is from about 0.1:5 to about 5:0.1. In some embodiments, the ratio of the alkoxylayed tristyrylphenol phosphate to the polyether modified trisiloxane is from about 0.1:2 to about 2:0.1.

In some embodiments, suitable surfactants are all substances that can enhance the wetting properties of the composition.

In certain embodiments which are not limiting, the surfactant can reduce the surface tension of water, increase the spreading abilities of a liquid, provide good absorption and smooth entrance of the active ingredients into the water.

In some embodiments, the surfactant is selected from sodium dioctyl sulphosuccinate, polysorbate, secondary alcohol ethoxylate and any combination thereof.

In some embodiments, the surfactant is sodium dioctyl sulphosuccinate.

In some embodiments, the surfactant is polysorbate.

In some embodiments, the surfactant is secondary alcohol ethoxylate.

In some embodiments, the polysorbate is selected from polyoxyethylene sorbitan monolaurate, polyoxyethylene polyoxypropylen sorbitan monolaurate, polyoxyethylene sorbitan monopalmitate, polyoxyethylene sorbitan monostearate, polyoxyethylene sorbitan monooleate or any combination thereof.

In some embodiments, the polysorbate is polyoxyethylene sorbitan monolaurate.

Non limiting Examples of polysorbates include TWEEN® 20, TWEEN® 40, TWEEN® 60 and TWEEN® 80.

In some embodiments, the secondary alcohol ethoxylate is C11-C15 secondary alcohol ethoxylate.

In some embodiments, the secondary alcohol ethoxylate is C12-C14 secondary alcohol ethoxylate.

In some embodiments, the secondary alcohol ethoxylate is C11-C15 secondary alcohol ethoxylate with number of ethylene oxide units of about 3 to about 16. In some embodiments, the secondary alcohol ethoxylate is C11-C15 secondary alcohol ethoxylate with number of ethylene oxide units of about 3 to about 12. In some embodiments, the secondary alcohol ethoxylate is C11-C15 secondary alcohol ethoxylate with number of ethylene oxide units of about 3 to about 9. In one embodiment, the secondary alcohol ethoxylate is C11-C15 secondary alcohol ethoxylate with number of ethylene oxide units of about 9.

In some embodiments, the secondary alcohol ethoxylate is C12-C14 secondary alcohol ethoxylate with number of ethylene oxide units of about 3 to about 16. In some embodiments, the secondary alcohol ethoxylate is C12-C14 secondary alcohol ethoxylate with number of ethylene oxide units of about 3 to about 12. In some embodiments, the secondary alcohol ethoxylate is C12-C14 secondary alcohol ethoxylate with number of ethylene oxide units of about 3 to about 9. In one embodiment, the secondary alcohol ethoxylate is C12-C14 secondary alcohol ethoxylate with number of ethylene oxide units of about 9.

Non limiting example for secondary alcohol ethoxylate surfactants include TERGITOL™ 15-S-9.

In some embodiments, the amount of the anionic alkoxylated polyarylphenol is of about 0.5% to about 7% by weight, based on the total weight of the composition. In some embodiments, the amount of the anionic alkoxylated polyarylphenol is of about 1% to about 5% by weight, based on the total weight of the composition. In some embodiments, the amount of the anionic alkoxylated polyarylphenol is of about 1% to about 3% by weight, based on the total weight of the composition. In some embodiments, the amount of the anionic alkoxylated polyarylphenol is of about 1% to about 2% by weight, based on the total weight of the composition.

In some embodiments, the amount of the alkoxylayed tristyrylphenol phosphate is of about 0.5% to about 7% by weight, based on the total weight of the composition. In some embodiments, the amount of the alkoxylayed tristyrylphenol phosphate is of about 1% to about 5% by weight, based on the total weight of the composition. In some embodiments, the amount of the alkoxylayed tristyrylphenol phosphate is of about 1% to about 3% by weight, based on the total weight of the composition. In some embodiments, the amount of the alkoxylayed tristyrylphenol phosphate is of about 1% to about 2% by weight, based on the total weight of the composition.

In some embodiments, the amount of 2,4,6-Tris(1-phenylethyl)phenol polyoxyethylenated phosphate is of about 1% to about 7% by weight, based on the total weight of the composition. In some embodiments, the amount of 2,4,6-Tris(1-phenylethyl)phenol polyoxyethylenated phosphate is of about 1% to about 5% by weight, based on the total weight of the composition. In some embodiments, the amount of 2,4,6-Tris(1-phenylethyl)phenol polyoxyethylenated phosphate is of about 1% to about 3% by weight, based on the total weight of the composition. In some embodiments, the amount of 2,4,6-Tris(1-phenylethyl)phenol polyoxyethylenated phosphate is of about 1% to about 2% by weight, based on the total weight of the composition.

In some embodiments, the amount of 2,4,6-Tris(1-phenylethyl)phenol polyoxyethylenated phosphate with about 16 unites of ethylene oxide is of about 1% to about 7% by weight, based on the total weight of the composition. In some embodiments, the amount 2,4,6-Tris(1-phenylethyl)phenol polyoxyethylenated phosphate with about 16 unites of ethylene oxide is of about 1% to about 5% by weight, based on the total weight of the composition. In some embodiments, the amount of 2,4,6-Tris(1-phenylethyl)phenol polyoxyethylenated phosphate with about 16 unites of ethylene oxide is of about 1% to about 3% by weight, based on the total weight of the composition. In some embodiments, the amount of 2,4,6-Tris(1-phenylethyl)phenol polyoxyethylenated phosphate with about 16 unites of ethylene oxide is of about 1% to about 2% by weight, based on the total weight of the composition.

In some embodiments, the amount of 2,4,6-Tris(1-phenylethyl)phenol polyoxyethylenated phosphate with number of ethylene oxide unites of about 16 to about 54 is of about 1% to about 7% by weight, based on the total weight of the composition. In some embodiments, the amount 2,4,6-Tris(1-phenylethyl)phenol polyoxyethylenated phosphate with number of ethylene oxide unites of about 16 to about 54 is of about 1% to about 5% by weight, based on the total weight of the composition. In some embodiments, the amount of 2,4,6-Tris(1-phenylethyl)phenol polyoxyethylenated phosphate with number of ethylene oxide unites of about 16 to about 54 is of about 1% to about 3% by weight, based on the total weight of the composition. In some embodiments, the amount of 2,4,6-Tris(1-phenylethyl)phenol polyoxyethylenated phosphate with number of ethylene oxide unites of about 16 to about 54 is of about 1% to about 2% by weight, based on the total weight of the composition.

In some embodiments, the amount of 2,4,6-Tris(1-phenylethyl)phenol polyoxyethylenated phosphate with number of ethylene oxide unites of about 16 is of about 1% to about 7% by weight, based on the total weight of the composition. In some embodiments, the amount 2,4,6-Tris(1-phenylethyl)phenol polyoxyethylenated phosphate with number of ethylene oxide unites of about 16 is of about 1% to about 5% by weight, based on the total weight of the composition. In some embodiments, the amount of 2,4,6-Tris(1-phenylethyl)phenol polyoxyethylenated phosphate with number of ethylene oxide unites of about 16 is of about 1% to about 3% by weight, based on the total weight of the composition. In some embodiments, the amount of 2,4,6-Tris(1-phenylethyl)phenol polyoxyethylenated phosphate with number of ethylene oxide unites of about 16 is of about 1% to about 2% by weight, based on the total weight of the composition.

In some embodiments, the amount of polysiloxane is of about 0.05% to about 0.5% by weight, based on the total weight of the composition. In some embodiments, the amount of polysiloxane is of about 0.1% to about 0.5% by weight, based on the total weight of the composition.

In some embodiments, the amount of polyether modified trisiloxane is of about 0.05% to about 0.5% by weight, based on the total weight of the composition. In some embodiments, the amount of polyether modified trisiloxane is of about 0.1% to about 0.5% by weight, based on the total weight of the composition.

In some embodiments, the amount of 3-[methyl-bis(trimethylsilyloxy)silyl]propan-1-ol is of about 0.05% to about 0.5% by weight, based on the total weight of the composition. In some embodiments, the amount of 3-[methyl-bis(trimethylsilyloxy)silyl]propan-1-ol is of about 0.1% to about 0.5% by weight, based on the total weight of the composition.

In some embodiments, the amount of the surfactant is of about 0.5% to about 5% by weight, based on the total weight of the composition. In some embodiments, the amount of the additional surfactant is of about 0.5% to about 3% by weight, based on the total weight of the composition.

In some embodiments, the amount of the surfactant is of about 0.5% to about 5% by weight, based on the total weight of the composition. In some embodiments, the amount of the surfactant is of about 0.5% to about 3% by weight, based on the total weight of the composition.

In some embodiments, the amount of sodium dioctyl sulphosuccinate is of about 0.5% to about 5% by weight, based on the total weight of the composition. In some embodiments, the amount of sodium dioctyl sulphosuccinate is of about 0.5% to about 3% by weight, based on the total weight of the composition.

In some embodiments, the amount of polysorbate is of about 0.5% to about 5% by weight, based on the total weight of the composition. In some embodiments, the amount of polysorbate is of about 0.5% to about 3% by weight, based on the total weight of the composition.

In some embodiments, the amount of polyoxyethylene sorbitan monolaurate is of about 0.5% to about 5% by weight, based on the total weight of the composition. In some embodiments, the amount of polyoxyethylene sorbitan monolaurate is of about 0.5% to about 3% by weight, based on the total weight of the composition.

In some embodiments, the amount of secondary alcohol ethoxylate is of about 0.5% to about 5% by weight, based on the total weight of the composition. In some embodiments, the amount of secondary alcohol ethoxylate is of about 0.5% to about 3% by weight, based on the total weight of the composition.

In some embodiments, the amount of the C11-C15 secondary alcohol ethoxylate is of about 0.5% to about 5% by weight, based on the total weight of the composition. In some embodiments, the amount of the C11-C15 secondary alcohol ethoxylate is of about 0.5% to about 3% by weight, based on the total weight of the composition.

In some embodiments, the amount of the C12-C14 secondary alcohol ethoxylate is of about 0.5% to about 5% by weight, based on the total weight of the composition. In some embodiments, the amount of the C12-C14 secondary alcohol ethoxylate is of about 0.5% to about 3% by weight, based on the total weight of the composition.

In some embodiments, the C11-C15 secondary alcohol ethoxylate with number of ethylene oxide units of about 3 to about 16 is of about 0.5% to about 5% by weight, based on the total weight of the composition. In some embodiments, the C11-C15 secondary alcohol ethoxylate with number of ethylene oxide units of about 3 to about 12 is of about 0.5% to about 5% by weight, based on the total weight of the composition. In some embodiments, the C11-C15 secondary alcohol ethoxylate with number of ethylene oxide units of about 3 to about 9 is of about 0.5% to about 5% by weight, based on the total weight of the composition. In one embodiment, the C11-C15 secondary alcohol ethoxylate with number of ethylene oxide units of about 9 is of about 0.5% to about 5% by weight, based on the total weight of the composition.

In some embodiments, the C12-C14 secondary alcohol ethoxylate with number of ethylene oxide units of about 3 to about 16 is of about 0.5% to about 5% by weight, based on the total weight of the composition. In some embodiments, the C12-C14 secondary alcohol ethoxylate with number of ethylene oxide units of about 3 to about 12 is of about 0.5% to about 5% by weight, based on the total weight of the composition. In some embodiments, the C12-C14 secondary alcohol ethoxylate with number of ethylene oxide units of about 3 to about 9 is of about 0.5% to about 5% by weight, based on the total weight of the composition. In one embodiment, the C12-C14 secondary alcohol ethoxylate with number of ethylene oxide units of about 9 is of about 0.5% to about 5% by weight, based on the total weight of the composition.

In some embodiments, the amount of water is of about 10% to about 75% by weight, based on the total weight of the composition. In some embodiments, the amount of water is of about 10% to about 70% by weight, based on the total weight of the composition. In some embodiments, the amount of water is of about 30% to about 70% by weight, based on the total weight of the composition. In some embodiments, the amount of water is of about 40% to about 70% by weight, based on the total weight of the composition. In some embodiments, the amount of water is of about 50% to about 70% by weight, based on the total weight of the composition.

In some embodiments, the composition further comprises at least one dispersing agent.

In some embodiments, the dispersing agent is selected from polycarboxylate, acrylic copolymers, nonionic alkoxylated polyarylphenol, naphthalene sulfonate condensate and any combination thereof.

In some embodiments, the amount of the dispersing agent is of about 1% to about 7% by weight, based on the total weight of the composition.

In some embodiments, the composition further comprises at least one adjuvant.

In some embodiments, the agrochemical suspension concentrate composition comprising:
a. at least one ketoenol insecticide
b. at least one mitochondrial complex I electron transport inhibitor insecticide
c. a wetting system comprising of:
   1. from about 0.5% to about 7% by weight, based on the total weight of the composition of at least one anionic alkoxylated polyarylphenol
   2. from about 0.05% to about 0.5% by weight, based on the total weight of the composition of at least one polysiloxane
   3. from about 0.5% to about 5% by weight, based on the total weight of the composition of at least one additional surfactant; and
d. water.

In some embodiments, the agrochemical suspension concentrate composition comprising:
a. at least one ketoenol insecticide
b. at least one mitochondrial complex I electron transport inhibitor insecticide
c. a wetting system comprising of:
   1. from about 1% to about 3% by weight, based on the total weight of the composition of at least one anionic alkoxylated polyarylphenol
   2. from about 0.1% to about 0.5% by weight, based on the total weight of the composition of at least one polysiloxane
   3. from about 0.5% to about 3% by weight, based on the total weight of the composition of at least one additional surfactant; and
d. water.

In some embodiments, the agrochemical suspension concentrate composition comprising:
a. at least one ketoenol insecticide
b. at least one mitochondrial complex I electron transport inhibitor insecticide
c. a wetting system comprising of:
   1. from about 1% to about 2% by weight, based on the total weight of the composition of at least one anionic alkoxylated polyarylphenol
   2. from about 0.1% to about 0.5% by weight, based on the total weight of the composition of at least one polysiloxane
   3. from about 0.5% to about 3% by weight, based on the total weight of the composition of at least one additional surfactant; and
d. water.

In some embodiments, the agrochemical suspension concentrate composition comprising:
a. spirotetramat
b. fenpyroximate
c. a wetting system comprising of:
   1. from about 0.5% to about 7% by weight, based on the total weight of the composition of at least one anionic alkoxylated polyarylphenol
   2. from about 0.05% to about 0.5% by weight, based on the total weight of the composition of at least one polysiloxane
   3. from about 0.5% to about 5% by weight, based on the total weight of the composition of at least one additional surfactant; and
d. water.

In some embodiments, the agrochemical suspension concentrate composition comprising:
a. spirotetramat
b. fenpyroximate
c. a wetting system comprising of:
   1. from about 1% to about 3% by weight, based on the total weight of the composition of at least one anionic alkoxylated polyarylphenol
   2. from about 0.1% to about 0.5% by weight, based on the total weight of the composition of at least one polysiloxane
   3. from about 0.5% to about 3% by weight, based on the total weight of the composition of at least one additional surfactant; and
d. water.

In some embodiments, the agrochemical suspension concentrate composition comprising:
a. spirotetramat
b. fenpyroximate
c. a wetting system comprising of:
   1. from about 1% to about 2% by weight, based on the total weight of the composition of at least one anionic alkoxylated polyarylphenol
   2. from about 0.1% to about 0.5% by weight, based on the total weight of the composition of at least one polysiloxane
   3. from about 0.5% to about 3% by weight, based on the total weight of the composition of at least one additional surfactant; and
d. water.

In some embodiments, the agrochemical suspension concentrate composition comprising:
a. spirotetramat
b. fenpyroximate
c. from about 0.5% to about 7% by weight, based on the total weight of the composition of at least one alkoxylayed styrenated phenol
d. from about 0.05% to about 0.5% by weight, based on the total weight of the composition of at least one polyether modified trisiloxane
e. from about 0.5% to about 5% by weight, based on the total weight of the composition of sodium dioctyl sulphosuccinate and/or at least one polyoxyethylenesorbitan monolaurate
and
f. water.

In some embodiments, the agrochemical suspension concentrate composition comprising:
a. from about 1% to about 60% by weight, based on the total weight of the composition of at least one ketoenol insecticide
b. from about 1% to about 40% by weight, based on the total weight of the composition of at least one mitochondrial complex I electron transport inhibitor insecticide
c. a wetting system comprising of:
   1. from about 0.5% to about 7% by weight, based on the total weight of the composition of at least one anionic alkoxylated polyarylphenol
   2. from about 0.05% to about 0.5% by weight, based on the total weight of the composition of at least one polysiloxane
   3. from about 0.5% to about 5% by weight, based on the total weight of the composition of at least one additional surfactant; and
d. water.

In some embodiments, the agrochemical suspension concentrate composition comprising:
a. from about 1% to about 60% by weight, based on the total weight of the composition of at least one ketoenol insecticide
b. from about 1% to about 40% by weight, based on the total weight of the composition of at least one mitochondrial complex I electron transport inhibitor insecticide
c. a wetting system comprising of:
   1. from about 1% to about 3% by weight, based on the total weight of the composition of at least one anionic alkoxylated polyarylphenol
   2. from about 0.1% to about 0.5% by weight, based on the total weight of the composition of at least one polysiloxane
   3. from about 0.5% to about 3% by weight, based on the total weight of the composition of at least one additional surfactant; and
d. water.

In some embodiments, the agrochemical suspension concentrate composition comprising:
a. from about 1% to about 60% by weight, based on the total weight of the composition of at least one ketoenol insecticide
b. from about 1% to about 40% by weight, based on the total weight of the composition of at least one mitochondrial complex I electron transport inhibitor insecticide
c. a wetting system comprising of:
   1. from about 1% to about 2% by weight, based on the total weight of the composition of at least one anionic alkoxylated polyarylphenol
   2. from about 0.1% to about 0.5% by weight, based on the total weight of the composition of at least one polysiloxane
   3. from about 0.5% to about 3% by weight, based on the total weight of the composition of at least one additional surfactant; and
d. water.

In some embodiments, the agrochemical suspension concentrate composition comprising:
a. from about 1% to about 20% by weight, based on the total weight of the composition of at least one ketoenol insecticide
b. from about 1% to about 20% by weight, based on the total weight of the composition of at least one mitochondrial complex I electron transport inhibitor insecticide
c. a wetting system comprising of:
   1. from about 0.5% to about 7% by weight, based on the total weight of the composition of at least one anionic alkoxylated polyarylphenol
   2. from about 0.05% to about 0.5% by weight, based on the total weight of the composition of at least one polysiloxane
   3. from about 0.5% to about 5% by weight, based on the total weight of the composition of at least one additional surfactant; and
d. water.

In some embodiments, the agrochemical suspension concentrate composition comprising:
a. from about 1% to about 20% by weight, based on the total weight of the composition of at least one ketoenol insecticide
b. from about 1% to about 20% by weight, based on the total weight of the composition of at least one mitochondrial complex I electron transport inhibitor insecticide
c. a wetting system comprising of:
   1. from about 1% to about 3% by weight, based on the total weight of the composition of at least one anionic alkoxylated polyarylphenol
   2. from about 0.1% to about 0.5% by weight, based on the total weight of the composition of at least one polysiloxane
   3. from about 0.5% to about 3% by weight, based on the total weight of the composition of at least one additional surfactant; and
d. water.

In some embodiments, the agrochemical suspension concentrate composition comprising:
a. from about 1% to about 20% by weight, based on the total weight of the composition of at least one ketoenol insecticide
b. from about 1% to about 20% by weight, based on the total weight of the composition of at least one mitochondrial complex I electron transport inhibitor insecticide
c. a wetting system comprising of:
   1. from about 1% to about 2% by weight, based on the total weight of the composition of at least one anionic alkoxylated polyarylphenol
   2. from about 0.1% to about 0.5% by weight, based on the total weight of the composition of at least one polysiloxane
   3. from about 0.5% to about 3% by weight, based on the total weight of the composition of at least one additional surfactant; and
d. water.

In some embodiments, the agrochemical suspension concentrate composition comprising:
a. from about 1% to about 15% by weight, based on the total weight of the composition of at least one ketoenol insecticide
b. from about 1% to about 10% by weight, based on the total weight of the composition of at least one mitochondrial complex I electron transport inhibitor insecticide
c. a wetting system comprising of:
   1. from about 0.5% to about 7% by weight, based on the total weight of the composition of at least one anionic alkoxylated polyarylphenol
   2. from about 0.05% to about 0.5% by weight, based on the total weight of the composition of at least one polysiloxane
   3. from about 0.5% to about 5% by weight, based on the total weight of the composition of at least one additional surfactant; and
d. water.

In some embodiments, the agrochemical suspension concentrate composition comprising:
a. from about 1% to about 15% by weight, based on the total weight of the composition of at least one ketoenol insecticide
b. from about 1% to about 10% by weight, based on the total weight of the composition of at least one mitochondrial complex I electron transport inhibitor insecticide
c. a wetting system comprising of:
   1. from about 1% to about 3% by weight, based on the total weight of the composition of at least one anionic alkoxylated polyarylphenol
   2. from about 0.1% to about 0.5% by weight, based on the total weight of the composition of at least one polysiloxane
   3. from about 0.5% to about 3% by weight, based on the total weight of the composition of at least one additional surfactant; and
d. water.

In some embodiments, the agrochemical suspension concentrate composition comprising:
a. from about 1% to about 15% by weight, based on the total weight of the composition of at least one ketoenol insecticide
b. from about 1% to about 10% by weight, based on the total weight of the composition of at least one mitochondrial complex I electron transport inhibitor insecticide
c. a wetting system comprising of:
   1. from about 1% to about 2% by weight, based on the total weight of the composition of at least one anionic alkoxylated polyarylphenol
   2. from about 0.1% to about 0.5% by weight, based on the total weight of the composition of at least one polysiloxane
   3. from about 0.5% to about 3% by weight, based on the total weight of the composition of at least one additional surfactant; and
d. water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of fenpyroximate
c. a wetting system comprising of:
   1. from about 0.5% to about 7% by weight, based on the total weight of the composition of at least one anionic alkoxylated polyarylphenol
   2. from about 0.05% to about 0.5% by weight, based on the total weight of the composition of at least one polysiloxane
   3. from about 0.5% to about 5% by weight, based on the total weight of the composition of at least one additional surfactant; and
d. water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of fenpyroximate
c. a wetting system comprising of:
   1. from about 1% to about 3% by weight, based on the total weight of the composition of at least one anionic alkoxylated polyarylphenol
   2. from about 0.1% to about 0.5% by weight, based on the total weight of the composition of at least one polysiloxane
   3. from about 0.5% to about 3% by weight, based on the total weight of the composition of at least one additional surfactant; and
d. water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of
c. a wetting system comprising of:
   1. from about 1% to about 2% by weight, based on the total weight of the composition of at least one anionic alkoxylated polyarylphenol
   2. from about 0.1% to about 0.5% by weight, based on the total weight of the composition of at least one polysiloxane
   3. from about 0.5% to about 3% by weight, based on the total weight of the composition of at least one additional surfactant; and
d. water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 0.5% to about 7% by weight, based on the total weight of the composition of at least one anionic alkoxylated polyarylphenol
   2. from about 0.05% to about 0.5% by weight, based on the total weight of the composition of at least one polysiloxane
   3. from about 0.5% to about 5% by weight, based on the total weight of the composition of at least one additional surfactant; and
d. water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 1% to about 3% by weight, based on the total weight of the composition of at least one anionic alkoxylated polyarylphenol
   2. from about 0.1% to about 0.5% by weight, based on the total weight of the composition of at least one polysiloxane
   3. from about 0.5% to about 3% by weight, based on the total weight of the composition of at least one additional surfactant; and
d. water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 1% to about 2% by weight, based on the total weight of the composition of at least one anionic alkoxylated polyarylphenol
   2. from about 0.1% to about 0.5% by weight, based on the total weight of the composition of at least one polysiloxane
   3. from about 0.5% to about 3% by weight, based on the total weight of the composition of at least one additional surfactant; and
d. water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 0.5% to about 7% by weight, based on the total weight of the composition of at least one anionic alkoxylated polyarylphenol
   2. from about 0.05% to about 0.5% by weight, based on the total weight of the composition of at least one polysiloxane
   3. from about 0.5% to about 5% by weight, based on the total weight of the composition of at least one additional surfactant; and
d. water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 1% to about 3% by weight, based on the total weight of the composition of at least one anionic alkoxylated polyarylphenol
   2. from about 0.1% to about 0.5% by weight, based on the total weight of the composition of at least one polysiloxane
   3. from about 0.5% to about 3% by weight, based on the total weight of the composition of at least one additional surfactant; and
d. water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 1% to about 2% by weight, based on the total weight of the composition of at least one anionic alkoxylated polyarylphenol
   2. from about 0.1% to about 0.5% by weight, based on the total weight of the composition of at least one polysiloxane
   3. from about 0.5% to about 3% by weight, based on the total weight of the composition of at least one additional surfactant; and
d. water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of at least one additional surfactant; and
d. water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of at least one additional surfactant; and
d. water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of at least one additional surfactant; and
d. water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of at least one additional surfactant; and
d. water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of at least one additional surfactant; and
d. water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of at least one additional surfactant; and
d. water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of at least one additional surfactant; and
d. water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of at least one additional surfactant; and
d. water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of at least one additional surfactant; and
d. water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of sodium dioctyl sulphosuccinate; and
d. water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of sodium dioctyl sulphosuccinate; and
d. water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of sodium dioctyl sulphosuccinate; and
d. water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of sodium dioctyl sulphosuccinate; and
d. water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of sodium dioctyl sulphosuccinate; and
d. water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of sodium dioctyl sulphosuccinate; and
d. water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of sodium dioctyl sulphosuccinate; and
d. water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of sodium dioctyl sulphosuccinate; and
d. water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of sodium dioctyl sulphosuccinate; and
d. water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of polysorbate; and
d. water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of polysorbate; and
d. water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of polysorbate; and
d. water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of polysorbate; and
d. water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of polysorbate; and
d. water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of polysorbate; and
d. water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of polysorbate; and
d. water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of polysorbate; and
d. water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of polysorbate; and
d. water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of polyoxyethylene sorbitan monolaurate; and
d. water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of polyoxyethylene sorbitan monolaurate; and
d. water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of polyoxyethylene sorbitan monolaurate; and
d. water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of polyoxyethylene sorbitan monolaurate; and
d. water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of polyoxyethylene sorbitan monolaurate; and
d. water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of polyoxyethylene sorbitan monolaurate; and
d. water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of polyoxyethylene sorbitan monolaurate; and
d. water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of polyoxyethylene sorbitan monolaurate; and
d. water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of polyoxyethylene sorbitan monolaurate; and
d. water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of secondary alcohol ethoxylate; and
d. water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of secondary alcohol ethoxylate; and
d. water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of secondary alcohol ethoxylate; and
d. water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of secondary alcohol ethoxylate; and
d. water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of secondary alcohol ethoxylate; and
d. water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of secondary alcohol ethoxylate; and
d. water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of secondary alcohol ethoxylate; and
d. water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of secondary alcohol ethoxylate; and
d. water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of secondary alcohol ethoxylate; and
d. water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of C11-C15 secondary alcohol ethoxylate; and
d. water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of C11-C15 secondary alcohol ethoxylate; and
d. water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of C11-C15 secondary alcohol ethoxylate; and
d. water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of C11-C15 secondary alcohol ethoxylate; and
d. water.

In some embodiments, the agrochemical suspension concentrate composition comprising:

a. from about 1% to about 20% by weight, based on the total weight of the composition of spirotetramat
b. from about 1% to about 20% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of C11-C15 secondary alcohol ethoxylate; and
d. water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of C11-C15 secondary alcohol ethoxylate; and
d. water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of C11-C15 secondary alcohol ethoxylate; and
d. water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of C11-C15 secondary alcohol ethoxylate; and
d. water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of C11-C15 secondary alcohol ethoxylate; and
d. water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of C12-C14 secondary alcohol ethoxylate; and
d. water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of C12-C14 secondary alcohol ethoxylate; and
d. water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of C12-C14 secondary alcohol ethoxylate; and
d. water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of C12-C14 secondary alcohol ethoxylate; and
d. water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of C12-C14 secondary alcohol ethoxylate; and
d. water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of C12-C14 secondary alcohol ethoxylate; and
d. water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of C12-C14 secondary alcohol ethoxylate; and
d. water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of C12-C14 secondary alcohol ethoxylate; and
d. water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of C12-C14 secondary alcohol ethoxylate; and
d. water.

In some embodiments, the agrochemical suspension concentrate composition comprising:
a. from about 1% to about 60% by weight, based on the total weight of the composition of at least one ketoenol insecticide
b. from about 1% to about 40% by weight, based on the total weight of the composition of at least one mitochondrial complex I electron transport inhibitor insecticide
c. a wetting system comprising of:
   1. from about 1% to about 3% by weight, based on the total weight of the composition of at least one anionic alkoxylated polyarylphenol
   2. from about 0.1% to about 0.5% by weight, based on the total weight of the composition of at least one polysiloxane
   3. from about 0.5% to about 3% by weight, based on the total weight of the composition of at least one additional surfactant; and
d. from about 50% to about 75% by weight, based on the total weight of the composition of water.

In some embodiments, the agrochemical suspension concentrate composition comprising:
a. from about 1% to about 60% by weight, based on the total weight of the composition of at least one ketoenol insecticide
b. from about 1% to about 40% by weight, based on the total weight of the composition of at least one mitochondrial complex I electron transport inhibitor insecticide
c. a wetting system comprising of:
   1. from about 1% to about 2% by weight, based on the total weight of the composition of at least one anionic alkoxylated polyarylphenol
   2. from about 0.1% to about 0.5% by weight, based on the total weight of the composition of at least one polysiloxane
   3. from about 0.5% to about 3% by weight, based on the total weight of the composition of at least one additional surfactant; and
d. from about 50% to about 75% by weight, based on the total weight of the composition of water.

In some embodiments, the agrochemical suspension concentrate composition comprising:
a. from about 1% to about 20% by weight, based on the total weight of the composition of at least one ketoenol insecticide
b. from about 1% to about 20% by weight, based on the total weight of the composition of at least one mitochondrial complex I electron transport inhibitor insecticide
c. a wetting system comprising of:
   1. from about 0.5% to about 7% by weight, based on the total weight of the composition of at least one anionic alkoxylated polyarylphenol
   2. from about 0.05% to about 0.5% by weight, based on the total weight of the composition of at least one polysiloxane
   3. from about 0.5% to about 5% by weight, based on the total weight of the composition of at least one additional surfactant; and
d. from about 50% to about 75% by weight, based on the total weight of the composition of water.

In some embodiments, the agrochemical suspension concentrate composition comprising:
a. from about 1% to about 20% by weight, based on the total weight of the composition of at least one ketoenol insecticide
b. from about 1% to about 20% by weight, based on the total weight of the composition of at least one mitochondrial complex I electron transport inhibitor insecticide
c. a wetting system comprising of:
   4. from about 1% to about 3% by weight, based on the total weight of the composition of at least one anionic alkoxylated polyarylphenol
   5. from about 0.1% to about 0.5% by weight, based on the total weight of the composition of at least one polysiloxane
   6. from about 0.5% to about 3% by weight, based on the total weight of the composition of at least one additional surfactant; and
d. from about 50% to about 75% by weight, based on the total weight of the composition of water.

In some embodiments, the agrochemical suspension concentrate composition comprising:
a. from about 1% to about 20% by weight, based on the total weight of the composition of at least one ketoenol insecticide
b. from about 1% to about 20% by weight, based on the total weight of the composition of at least one mitochondrial complex I electron transport inhibitor insecticide
c. a wetting system comprising of:
   1. from about 1% to about 2% by weight, based on the total weight of the composition of at least one anionic alkoxylated polyarylphenol
   2. from about 0.1% to about 0.5% by weight, based on the total weight of the composition of at least one polysiloxane
   3. from about 0.5% to about 3% by weight, based on the total weight of the composition of at least one additional surfactant; and
d. from about 50% to about 75% by weight, based on the total weight of the composition of water.

In some embodiments, the agrochemical suspension concentrate composition comprising:
a. from about 1% to about 15% by weight, based on the total weight of the composition of at least one ketoenol insecticide
b. from about 1% to about 10% by weight, based on the total weight of the composition of at least one mitochondrial complex I electron transport inhibitor insecticide
c. a wetting system comprising of:
   1. from about 0.5% to about 7% by weight, based on the total weight of the composition of at least one anionic alkoxylated polyarylphenol
   2. from about 0.05% to about 0.5% by weight, based on the total weight of the composition of at least one polysiloxane
   3. from about 0.5% to about 5% by weight, based on the total weight of the composition of at least one additional surfactant; and
d. from about 50% to about 75% by weight, based on the total weight of the composition of water.

In some embodiments, the agrochemical suspension concentrate composition comprising:
a. from about 1% to about 15% by weight, based on the total weight of the composition of at least one ketoenol insecticide
b. from about 1% to about 10% by weight, based on the total weight of the composition of at least one mitochondrial complex I electron transport inhibitor insecticide
c. a wetting system comprising of:
   1. from about 1% to about 3% by weight, based on the total weight of the composition of at least one anionic alkoxylated polyarylphenol
   2. from about 0.1% to about 0.5% by weight, based on the total weight of the composition of at least one polysiloxane
   3. from about 0.5% to about 3% by weight, based on the total weight of the composition of at least one additional surfactant; and
d. from about 50% to about 75% by weight, based on the total weight of the composition of water.

In some embodiments, the agrochemical suspension concentrate composition comprising:
a. from about 1% to about 15% by weight, based on the total weight of the composition of at least one ketoenol insecticide
b. from about 1% to about 10% by weight, based on the total weight of the composition of at least one mitochondrial complex I electron transport inhibitor insecticide
c. a wetting system comprising of:
   1. from about 1% to about 2% by weight, based on the total weight of the composition of at least one anionic alkoxylated polyarylphenol
   2. from about 0.1% to about 0.5% by weight, based on the total weight of the composition of at least one polysiloxane
   3. from about 0.5% to about 3% by weight, based on the total weight of the composition of at least one additional surfactant; and
d. from about 50% to about 75% by weight, based on the total weight of the composition of water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of fenpyroximate
c. a wetting system comprising of:
   1. from about 0.5% to about 7% by weight, based on the total weight of the composition of at least one anionic alkoxylated polyarylphenol
   2. from about 0.05% to about 0.5% by weight, based on the total weight of the composition of at least one polysiloxane
   3. from about 0.5% to about 5% by weight, based on the total weight of the composition of at least one additional surfactant; and
d. from about 50% to about 75% by weight, based on the total weight of the composition of water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of fenpyroximate
c. a wetting system comprising of:
   1. from about 1% to about 3% by weight, based on the total weight of the composition of at least one anionic alkoxylated polyarylphenol
   2. from about 0.1% to about 0.5% by weight, based on the total weight of the composition of at least one polysiloxane
   3. from about 0.5% to about 3% by weight, based on the total weight of the composition of at least one additional surfactant; and
d. from about 50% to about 75% by weight, based on the total weight of the composition of water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of fenpyroximate
c. a wetting system comprising of:
   1. from about 1% to about 2% by weight, based on the total weight of the composition of at least one anionic alkoxylated polyarylphenol
   2. from about 0.1% to about 0.5% by weight, based on the total weight of the composition of at least one polysiloxane
   3. from about 0.5% to about 3% by weight, based on the total weight of the composition of at least one additional surfactant; and
d. from about 50% to about 75% by weight, based on the total weight of the composition of water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 0.5% to about 7% by weight, based on the total weight of the composition of at least one anionic alkoxylated polyarylphenol
   2. from about 0.05% to about 0.5% by weight, based on the total weight of the composition of at least one polysiloxane
   3. from about 0.5% to about 5% by weight, based on the total weight of the composition of at least one additional surfactant; and
d. from about 50% to about 75% by weight, based on the total weight of the composition of water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 1% to about 3% by weight, based on the total weight of the composition of at least one anionic alkoxylated polyarylphenol
   2. from about 0.1% to about 0.5% by weight, based on the total weight of the composition of at least one polysiloxane
   3. from about 0.5% to about 3% by weight, based on the total weight of the composition of at least one additional surfactant; and
d. from about 50% to about 75% by weight, based on the total weight of the composition of water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 1% to about 2% by weight, based on the total weight of the composition of at least one anionic alkoxylated polyarylphenol
   2. from about 0.1% to about 0.5% by weight, based on the total weight of the composition of at least one polysiloxane
   3. from about 0.5% to about 3% by weight, based on the total weight of the composition of at least one additional surfactant; and
d. from about 50% to about 75% by weight, based on the total weight of the composition of water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 0.5% to about 7% by weight, based on the total weight of the composition of at least one anionic alkoxylated polyarylphenol
   2. from about 0.05% to about 0.5% by weight, based on the total weight of the composition of at least one polysiloxane
   3. from about 0.5% to about 5% by weight, based on the total weight of the composition of at least one additional surfactant; and
d. from about 50% to about 75% by weight, based on the total weight of the composition of water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 1% to about 3% by weight, based on the total weight of the composition of at least one anionic alkoxylated polyarylphenol
   2. from about 0.1% to about 0.5% by weight, based on the total weight of the composition of at least one polysiloxane
   3. from about 0.5% to about 3% by weight, based on the total weight of the composition of at least one additional surfactant; and
d. from about 50% to about 75% by weight, based on the total weight of the composition of water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 1% to about 2% by weight, based on the total weight of the composition of at least one anionic alkoxylated polyarylphenol
   2. from about 0.1% to about 0.5% by weight, based on the total weight of the composition of at least one polysiloxane
   3. from about 0.5% to about 3% by weight, based on the total weight of the composition of at least one additional surfactant; and
d. from about 50% to about 75% by weight, based on the total weight of the composition of water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of at least one additional surfactant; and
d. from about 50% to about 75% by weight, based on the total weight of the composition of water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of at least one additional surfactant; and
d. from about 50% to about 75% by weight, based on the total weight of the composition of water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of fenpyroximate
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of at least one additional surfactant; and
d. from about 50% to about 75% by weight, based on the total weight of the composition of water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of at least one additional surfactant; and
d. from about 50% to about 75% by weight, based on the total weight of the composition of water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of at least one additional surfactant; and
d. from about 50% to about 75% by weight, based on the total weight of the composition of water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of at least one additional surfactant; and
d. from about 50% to about 75% by weight, based on the total weight of the composition of water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of at least one additional surfactant; and
d. from about 50% to about 75% by weight, based on the total weight of the composition of water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of at least one additional surfactant; and
d. from about 50% to about 75% by weight, based on the total weight of the composition of water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of at least one additional surfactant; and
d. from about 50% to about 75% by weight, based on the total weight of the composition of water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of sodium dioctyl sulphosuccinate; and
d. from about 50% to about 75% by weight, based on the total weight of the composition of water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of sodium dioctyl sulphosuccinate; and
d. from about 50% to about 75% by weight, based on the total weight of the composition of water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of fenpyroximate
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of sodium dioctyl sulphosuccinate; and
d. from about 50% to about 75% by weight, based on the total weight of the composition of water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of sodium dioctyl sulphosuccinate; and
d. from about 50% to about 75% by weight, based on the total weight of the composition of water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of sodium dioctyl sulphosuccinate; and
d. from about 50% to about 75% by weight, based on the total weight of the composition of water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of sodium dioctyl sulphosuccinate; and
d. from about 50% to about 75% by weight, based on the total weight of the composition of water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of sodium dioctyl sulphosuccinate; and
d. from about 50% to about 75% by weight, based on the total weight of the composition of water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of sodium dioctyl sulphosuccinate; and
d. from about 50% to about 75% by weight, based on the total weight of the composition of water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of sodium dioctyl sulphosuccinate; and
d. from about 50% to about 75% by weight, based on the total weight of the composition of water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of polysorbate; and
d. from about 50% to about 75% by weight, based on the total weight of the composition of water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of polysorbate; and
d. from about 50% to about 75% by weight, based on the total weight of the composition of water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of fenpyroximate
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of polysorbate; and
d. from about 50% to about 75% by weight, based on the total weight of the composition of water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of polysorbate; and
d. from about 50% to about 75% by weight, based on the total weight of the composition of water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of polysorbate; and
d. from about 50% to about 75% by weight, based on the total weight of the composition of water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of polysorbate; and
d. from about 50% to about 75% by weight, based on the total weight of the composition of water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of polysorbate; and
d. from about 50% to about 75% by weight, based on the total weight of the composition of water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of polysorbate; and
d. from about 50% to about 75% by weight, based on the total weight of the composition of water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of polysorbate; and
d. from about 50% to about 75% by weight, based on the total weight of the composition of water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of polyoxyethylene sorbitan monolaurate; and
d. from about 50% to about 75% by weight, based on the total weight of the composition of water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of polyoxyethylene sorbitan monolaurate; and
d. from about 50% to about 75% by weight, based on the total weight of the composition of water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of fenpyroximate
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of polyoxyethylene sorbitan monolaurate; and
d. from about 50% to about 75% by weight, based on the total weight of the composition of water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of polyoxyethylene sorbitan monolaurate; and
d. from about 50% to about 75% by weight, based on the total weight of the composition of water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of polyoxyethylene sorbitan monolaurate; and
d. from about 50% to about 75% by weight, based on the total weight of the composition of water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of polyoxyethylene sorbitan monolaurate; and
d. from about 50% to about 75% by weight, based on the total weight of the composition of water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of polyoxyethylene sorbitan monolaurate; and
d. from about 50% to about 75% by weight, based on the total weight of the composition of water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of polyoxyethylene sorbitan monolaurate; and
d. from about 50% to about 75% by weight, based on the total weight of the composition of water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of polyoxyethylene sorbitan monolaurate; and
d. from about 50% to about 75% by weight, based on the total weight of the composition of water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of secondary alcohol ethoxylate; and
d. from about 50% to about 75% by weight, based on the total weight of the composition of water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of secondary alcohol ethoxylate; and
d. from about 50% to about 75% by weight, based on the total weight of the composition of water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of secondary alcohol ethoxylate; and
d. from about 50% to about 75% by weight, based on the total weight of the composition of water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of secondary alcohol ethoxylate; and
d. from about 50% to about 75% by weight, based on the total weight of the composition of water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of secondary alcohol ethoxylate; and
d. from about 50% to about 75% by weight, based on the total weight of the composition of water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of secondary alcohol ethoxylate; and
d. from about 50% to about 75% by weight, based on the total weight of the composition of water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of secondary alcohol ethoxylate; and
d. from about 50% to about 75% by weight, based on the total weight of the composition of water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of secondary alcohol ethoxylate; and
d. from about 50% to about 75% by weight, based on the total weight of the composition of water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of secondary alcohol ethoxylate; and
d. from about 50% to about 75% by weight, based on the total weight of the composition of water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of C11-C15 secondary alcohol ethoxylate; and
d. from about 50% to about 75% by weight, based on the total weight of the composition of water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of C11-C15 secondary alcohol ethoxylate; and
d. water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of fenpyroximate
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of C11-C15 secondary alcohol ethoxylate; and
d. from about 50% to about 75% by weight, based on the total weight of the composition of water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of C11-C15 secondary alcohol ethoxylate; and
d. from about 50% to about 75% by weight, based on the total weight of the composition of water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of C11-C15 secondary alcohol ethoxylate; and
d. from about 50% to about 75% by weight, based on the total weight of the composition of water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of C11-C15 secondary alcohol ethoxylate; and
d. from about 50% to about 75% by weight, based on the total weight of the composition of water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of C11-C15 secondary alcohol ethoxylate; and
d. from about 50% to about 75% by weight, based on the total weight of the composition of water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of C11-C15 secondary alcohol ethoxylate; and
d. from about 50% to about 75% by weight, based on the total weight of the composition of water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of C11-C15 secondary alcohol ethoxylate; and
d. from about 50% to about 75% by weight, based on the total weight of the composition of water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of C12-C14 secondary alcohol ethoxylate; and
d. from about 50% to about 75% by weight, based on the total weight of the composition of water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of C12-C14 secondary alcohol ethoxylate; and
d. from about 50% to about 75% by weight, based on the total weight of the composition of water.

In some embodiments, the agrochemical suspension concentrate composition comprising:
a. from about 1% to about 60% by weight, based on the total weight of the composition of spirotetramat
b. from about 1% to about 40% by weight, based on the total weight of the composition of fenpyroximate
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of C12-C14 secondary alcohol ethoxylate; and
d. from about 50% to about 75% by weight, based on the total weight of the composition of water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of C12-C14 secondary alcohol ethoxylate; and
d. from about 50% to about 75% by weight, based on the total weight of the composition of water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of C12-C14 secondary alcohol ethoxylate; and
d. from about 50% to about 75% by weight, based on the total weight of the composition of water.

In some embodiments, the agrochemical suspension concentrate composition comprising:
a. from about 1% to about 20% by weight, based on the total weight of the composition of spirotetramat
b. from about 1% to about 20% by weight, based on the total weight of the composition of fenpyroximate
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of C12-C14 secondary alcohol ethoxylate; and
d. from about 50% to about 75% by weight, based on the total weight of the composition of water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 0.5% to about 7% by weight, based on the total weight of the composition of at least one alkoxylayed tristyrylphenol phosphate
   2. from about 0.05% to about 0.5% by weight, based on the total weight of the composition of at least one polyether modified trisiloxane
   3. from about 0.5% to about 5% by weight, based on the total weight of the composition of C12-C14 secondary alcohol ethoxylate; and
d. from about 50% to about 75% by weight, based on the total weight of the composition of water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 1% to about 3% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of C12-C14 secondary alcohol ethoxylate; and
d. from about 50% to about 75% by weight, based on the total weight of the composition of water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 1% to about 2% by weight, based on the total weight of the composition of at least one alkoxylayed tristyrylphenol phosphate
   2. from about 0.1% to about 0.5% by weight, based on the total weight of the composition of at least one polyether modified trisiloxane
   3. from about 0.5% to about 3% by weight, based on the total weight of the composition of C12-C14 secondary alcohol ethoxylate; and
d. from about 50% to about 75% by weight, based on the total weight of the composition of water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 1% to about 2% by weight, based on the total weight of the composition of 2,4,6-tris(1-phenylethyl)phenol polyoxyethylenated phosphate
   2. from about 0.1% to about 0.5% by weight, based on the total weight of the composition of 3-[methyl-bis(trimethylsilyloxy)silyl]propan-1-ol
   3. from about 0.5% to about 3% by weight, based on the total weight of the composition of C12-C14 secondary alcohol ethoxylate with number of ethylene oxide units of about 9; and
d. from about 50% to about 75% by weight, based on the total weight of the composition of water.

In some embodiments, the agrochemical suspension concentrate composition comprising:
a. from about 1% to about 15% by weight, based on the total weight of the composition of spirotetramat
b. from about 1% to about 10% by weight, based on the total weight of the composition of fenpyroximate
c. a wetting system comprising of:
   1. from about 1% to about 2% by weight, based on the total weight of the composition of 2,4,6-tris(1-phenylethyl)phenol polyoxyethylenated phosphate with number of ethylene oxide unites of about 16
   2. from about 0.1% to about 0.5% by weight, based on the total weight of the composition of 3-[methyl-bis(trimethylsilyloxy)silyl]propan-1-ol
   3. from about 0.5% to about 3% by weight, based on the total weight of the composition of C12-C14 secondary alcohol ethoxylate with number of ethylene oxide units of about 9; and
d. from about 50% to about 75% by weight, based on the total weight of the composition of water.

The compositions according to the invention remain stable even after prolonged storage at elevated temperatures or in the cold, since no crystal growth is observed.

The present invention also provides a method for controlling and/or preventing animal pests comprising applying an effective amount of the composition to a locus where the animal pest is to be controlled and/or prevented so as to thereby control and/or prevent the animal pest.

In some embodiments, the locus where the animal pests to be controlled is a crop field.

No limiting examples of suitable crops include cereals, such as wheat, barley, rye, oats, rice, maize, sorghum; beet, such as sugar, fodder beet; fruit, for example pomaceous fruit, stone fruit or soft fruit, such as apples, pears, avocado, plums, peaches, almonds, cherries, berries, for example strawberries, raspberries, blackberries; cinnamonium, camphor citrus fruit, such as oranges, lemons, grapefruit, tangerines; cucurbits, such as pumpkins, cucumbers, melons, vegetables, such as spinach, lettuce, asparagus, cabbages, carrots, onions, tomatoes, potatoes or peppers, chilli, okra, eggplants; leguminous crops, such as beans, lentils, peas, soya; oil crops, such as oilseed rape, mustard, poppies, olives, sunflowers, coconut, castor, cocoa, ground nuts; fibre plants, such as cotton, flax, hemp, jute; and also tobacco, nuts, coffee, sugarcane, tea, grapevines, hops, the plantain family, latex plants ornamentals and lauraceae.

The compositions of the invention can be used to combat and control infestations of animal pests such as Lepidoptera, Diptera, Hemiptera, Thysanoptera, Coleoptera, Hymenoptera and also other invertebrate pests, for example, acarine, nematode and mollusc pests. Insects, acarines, nematodes and molluscs are hereinafter collectively referred to as pests. The animal pests which may be combated and controlled by the use of the invention compounds include those animal pests associated with agriculture (which term includes the growing of crops for food and fibre products), horticulture and animal husbandry, forestry and the storage of products of vegetable origin (such as fruit, grain and timber). Non limiting examples of pest species which may be controlled by the compositions of the invention include Myzus persicae (aphid), Aphis gossypii (aphid), Aphis fabae (aphid), Lygus spp. (capsids), Dysdercus spp. (capsids), Nilaparvata lugens (planthopper), Nephotettixc incticeps (leafhopper), Nezara spp. (stinkbugs), Euschistus spp. (stinkbugs), Leptocorisa spp. (stinkbugs), Frankliniella occidentalis (thrip), Thrips spp. (thrips), Leptinotarsa decemlineata (Colorado potato beetle), Anthonomus grandis (boll weevil), Aonidiella spp. (scale insects), Pseudococcus SPP. (mealybugs) Trialeurodes spp. (white flies), Bemisia tabaci (white fly), Ostrinia nubilalis (European corn borer), Spodoptera littoralis (cotton leafworm), Heliothis virescens (tobacco budworm), Helicoverpa armigera (cotton bollworm), Helicoverpa zea (cotton bollworm), Sylepta derogata (cotton leaf roller), Pieris brassicae (white butterfly), Plutella xylostella (diamond back moth), Agrotis spp. (cutworms), Chilo suppressalis (rice stem borer), Locusta migratoria (locust), Chortiocetes terminifera (locust), Diabrotica spp. (rootworms), Panonychus ulmi (European red mite), Panonychus citri (citrus red mite), Tetranychus urticae (two-spotted spider mite), Tetranychus cinnabarinus (carmine spider mite), Phyllocoptruta oleivora (citrus rust mite), Polyphagotarsonemus latus (broad mite), Brevipalpus spp. (flat mites), Liriomyza spp. (leafminer), Meloidogyne spp. (root knot nematodes), Globodera spp. and Heterodera spp. (cyst nematodes), Pratylenchus spp. (lesion nematodes), Rhodopholus spp. (banana burrowing nematodes), Tylenchulus spp. (citrus nematodes), Haemonchus contortus (barber pole worm), Caenorhabditis elegans (vinegar eelworm), Trichostrongylus spp. (gastro intestinal nematodes) and Deroceras reticulatum (slug). From the order Acarina, for example, Acarus siro, Aceria sheldoni, Aculus schlechtendali, Amblyomma spp., Argas spp., Boophilus spp., Brevipalpus spp., Bryobia praetiosa, Calipitrimerus spp., Chorioptes spp., Dermanyssus gallinae, Eotetranychus carpini, Eriophyes spp., Hyalomma spp., Ixodes spp., Olygonychus pratensis, Ornithodoros spp., Panonychus spp., Phyllocoptruta oleivora, Polyphagotarsonemus latus, Psoroptes spp., Rhipicephalus spp., Rhizoglyphus spp., Sarcoptes spp., Tarsonemus spp, and Tetranychus spp.; From the order Coleoptera, for example, Agriotes spp., Anthonomus spp., Atomaria linearis, Chaetocnema tibialis, Cosmopolites spp., Curculio spp., Dermestes spp., Diabrotica spp., Epilachna spp., Eremnus spp., Leptinotarsa decemLineata, Lissorhoptrus spp., Melolontha spp., Orycaephilus spp., Otiorhynchus spp., Phlyctinus spp., Popillia spp., Psylliodes spp., Rhizopertha spp., Scarabeidae, Sitophilus spp., Sitotroga spp., Tenebrio spp., Tribolium spp, and Trogoderma spp.; From the order Diptera, for example, Aedes spp., Antherigona soccata, Bibio hortulanus, Calliphora erythrocephala, Ceratitis spp., Chrysomyia spp., Culex spp., Cuterebra spp., Dacus spp., Drosophila melanogaster, Fannia spp., Gastrophilus spp., Glossina spp., Hypoderma spp., Hyppobosca spp., Liriomyza spp., Lucilia spp., Melanagromyza spp., Musca spp., Oestrus spp., Orseolia spp., Oscinella frit, Pegomyia hyoscyami, Phorbia spp., Rhagoletis pomonella, Sciara spp., Stomoxys spp., Tabanus spp., Tannia spp, and Tipula spp.; From the order Heteroptera, for example, Cimex spp., Distantiella theobroma, Dysdercus spp., Euchistus spp., Eurygaster spp., Leptocorisa spp., Nezara spp., Piesma spp., Rhodnius spp., Sahlbergella singularis, Scotinophara spp, and Triatoma spp.; From the order Homoptera, for example Aleurothrixus floccosus, Aleyrodes brassicae, Aonidiella spp., Aphididae, Aphis spp., Aspidiotus spp., Bemisia tabaci, Ceroplaster spp., Chrysomphalus aonidium, Chrysomphalus dictyospermi, Coccus hesperidum, Empoasca spp., Eriosoma larigerum, Erythroneura spp., Gascardia spp., Laodelphax spp., Lecanium corni, Lepidosaphes spp., Macrosiphus spp., Myzus spp., Nephotettix spp., Nilaparvata spp., Parlatoria spp., Pemphigus spp., Planococcus spp., Pseudaulacaspis spp., Pseudococcus spp., Psylla spp., Pulvinaria aethiopica, Quadraspidiotus spp., Rhopalosiphum spp., Saissetia spp., Scaphoideus spp., Schizaphis spp., Sitobion spp., Trialeurodes vaporariorum, Trioza erytreae and Unaspis citri; From the order Hymenoptera, for example, Acromyrmex, Atta spp., Cephus spp., Diprion spp., Diprionidae, Gilpinia polytoma, Hoplocampa spp., Lasius spp., Monomorium pharaonis, Neodiprion spp., Solenopsis spp, and Vespa spp.; From the order Lepidoptera, for example, Acleris spp., Adoxophyes spp., Aegeria spp., Agrotis spp., Alabama argillaceae, Amylois spp., Anticarsia gemmatalis, Archips spp., Argyrotaenia spp., Autographa spp., Busseola fusca, Cadra cautella, Carposina nipponensis, ChNo spp., Choristoneura spp., Clysia ambiguella, Cnaphalocrocis spp., Cnephasia spp., Cochylis spp., Coleophora spp., Crocidolomia binotalis, Cryptophlebia leucotreta, Cydia spp., Diatraea spp., Diparopsis castanea, Earias spp., Ephestia spp., Eucosma spp., Eupoecilia ambiguella, Euproctis spp., Euxoa spp., Grapholita spp., Hedya nubiferana, Heliothis spp., Hellula undalis, Hyphantria cunea, Keiferia lycopersicella, Leucoptera scitella, Lithocollethis spp., Lobesia botrana, Lymantria spp., Lyonetia spp., Malacosoma spp., Mamestra brassicae, Manduca sexta, Operophtera spp., Ostrinia nubilalis, Pammene spp., Pandemis spp., Panolis flammea, Pectinophora gossypiela, Phthorimaea operculella, Pieris rapae, Pieris spp., Plutella xylostella, Prays spp., Scirpophaga spp., Sesamia spp., Sparganothis spp., Spodoptera spp., Synanthedon spp., Thaumetopoea spp., Tortrix spp., Trichoplusia ni and Yponomeuta spp.; from the order Thysanoptera, for example, Frankliniella spp., Hercinothrips spp., Scirtothrips aurantii, Taeniothrips spp., Thrips palmi and Thrips tabaci; and from the order Thysanura, for example, Lepisma saccharina.

In some embodiments, the composition is applied in an amount from about 0.5 L/ha to about 2 L/ha.

In some embodiments, the composition is applied in an amount from about 37 g/ha ketoenol insecticide to about 150 g/ha of ketoenol insecticide.

In some embodiments, the composition is applied in an amount from about 50 g/ha of mitochondrial complex I electron transport inhibitor insecticide to about 200 g/ha of mitochondrial complex I electron transport inhibitor insecticide.

In some embodiments, the composition is applied in an amount from about 37 g/ha of spirotetramat to about 150 g/ha of spirotetramat.

In some embodiments, the composition is applied in an amount from about 50 g/ha of fenpyroximate to about 200 g/ha of fenpyroximate.

In some embodiments, the compositions of the present invention disclosed herein are for the use for controlling and/or preventing animal pests.

The invention is illustrated by the following examples without limiting it thereby.

### EXAMPLES

### Example 1

TABLE 1
Spirotetramat and fenpyroximate formulation A

| Component | w/w % | g/L |
|---|---|---|
| spirotetramat | 7.21 | 75.00 |
| fenpyroximate | 9.62 | 100.00 |
| soprophor 3D33 | 1.00 | 10.40 |
| break thru s233 | 0.10 | 1.04 |
| Atlox 4913 | 2.00 | 20.80 |
| silcolapse 432 | 0.50 | 5.20 |
| Emcol 4500 | 0.50 | 5.20 |
| Van gel B | 0.50 | 5.20 |
| Xanthan gum | 0.30 | 3.12 |
| Proxel GXL | 0.30 | 3.12 |
| Propylen Glycol | 7.00 | 72.80 |
| Soft water | 70.97 | 738.12 |

### Preparation Procedure:

All the stages take place at room temperature about 23° C.±2° C.

### Stage 1—

Van gel B was added to water (156 g/L) and high shear was applied.
Spirotetramat, Fenperoxymate, ATLOX 4913, Break Thru s233, Soprophor 3D33, Emcol 4500 and Silcolapse 432 (half the amount) were added to the water with the van gel B and mixed.
High shear was applied.
The mixture was milled to get the desired particle size distribution LT 6 microns.

### Stage 2—

Extra water (up to 1000 L), silcolapse 432 (half the Amount), propylene glycol, proxel GXL and Xanthan Gum were added; if needed adjust with HCl/NaOH solutions to get pH between 4-6.
The solution was mixed until homogenous suspension was obtained.

### Example 2

TABLE 2
Spirotetramat and fenpyroximate formulation B

| Component | w/w % | g/L |
|---|---|---|
| Spirotetramat tech | 7.21 | 75 |
| Fenpyroximate tech | 9.62 | 100 |
| Soprophor 3D33 (Tristyrylphenol ethoxylate phosphate | 2.00 | 20.8 |
| ester) | | |
| SURFOM 1322 SC (Tristyrylphenol EO phosphate | 2.00 | 20.8 |
| ester, TEA salt) | | |
| Break Thru s233 (non-ionic trisiloxane surfactant) | 0.10 | 1.04 |
| Tween 20 (Polyoxyethylenesorbitan monolaurate) | 2.00 | 20.8 |
| Atlox 4913 (Acrylic copolymer solution) | 3.00 | 31.2 |
| Silcolapse 432 (non-ionic, polydimethylsiloxanic oil | 0.5 | 5.2 |
| based, aqueous emulsion) | | |
| Propylene glycol | 7 | 72.8 |
| Xanthan gum | 0.30 | 3.12 |
| Proxel GXL | 0.30 | 3.12 |
| Water | 65.97 | 686.12 |

### Preparation Procedure:

All the stages take place at room temperature about 23° C.±2° C.

### Stage 1—

Spirotetramat, Fenperoxymate, ATLOX 4913, Break Thru s233, Soprophor 3D33, Surfom 1322 sc, Tween 20, Silcolapse 432 (half the amount) and water (156 g/L) were mixed.
High shear was applied.
The mixture was milled to get the desired particle size distribution LT 6 microns.

### Stage 2—

Extra water (up to 1000 L), silcolapse 432 (half the Amount), propylene glycol, proxel GXL and Xanthan Gum were added; if needed adjust with HCl/NaOH solutions to get pH between 4-6.
The solution was mixed until homogenous suspension was obtained.

### Example 3

TABLE 3
Spirotetramat and fenpyroximate formulation C

| Component | w/w % | g/L |
|---|---|---|
| Spirotetramat tech | 9.62 | 100.00 |
| Fenpyroximate tech | 9.62 | 100.00 |
| Soprophor 3D33 (Tristyrylphenol ethoxylate phosphate | 2.00 | 20.80 |
| ester) | | |
| SURFOM 1322 SC (Tristyrylphenol EO phosphate | 1.00 | 10.40 |
| ester, TEA salt) | | |
| Break Thru s233 (non-ionic trisiloxane surfactant) | 0.10 | 1.04 |
| Tergitol 15-s-9 (Secondary Alcohol Ethoxylate) | 1.00 | 10.40 |
| Atlox 4913 (Acrylic copolymer solution) | 2.00 | 20.80 |
| Silcolapse 432 (non-ionic, polydimethylsiloxanic oil | 0.50 | 5.20 |
| based, aqueous emulsion) | | |
| Propylene glycol | 7.00 | 72.80 |
| Xanthan gum | 0.30 | 3.12 |
| Proxel GXL | 0.30 | 3.12 |
| Water | 66.57 | 692.32 |

### Preparation Procedure:

All the stages take place at room temperature about 23° C.±2° C.

### Stage 1—

Spirotetramat, Fenperoxymate, ATLOX 4913, Break Thru s233, Soprophor 3D33, Surfom 1322 sc, Tergitol 15-s-9, Silcolapse 432 (half the amount) and water (156 g/L) were mixed.
High shear was applied.
The mixture was milled to get the desired particle size distribution LT 6 microns.

### Stage 2—

Extra water (up to 1000 L), silcolapse 432 (half the Amount), propylene glycol, proxel GXL and Xanthan Gum were added; if needed adjust with HCl/NaOH solutions to get pH between 4-6.
The solution was mixed until homogenous suspension was obtained.

### Example 4

TABLE 4
Spirotetramat and fenpyroximate formulation D

| Component | w/w % | g/L |
|---|---|---|
| Spirotetramat tech | 9.62 | 100.00 |
| Fenpyroximate tech | 9.62 | 100.00 |
| Soprophor 3D33 (Tristyrylphenol ethoxylate phosphate | 1.00 | 10.40 |
| ester) | | |
| Break Thru s233 (non-ionic trisiloxane surfactant) | 0.10 | 1.04 |
| Atlox 4913 (Acrylic copolymer solution) | 2.00 | 20.80 |
| Silcolapse 432 (non-ionic, polydimethylsiloxanic oil | 0.50 | 5.20 |
| based, aqueous emulsion) | | |
| Propylene glycol | 7.00 | 72.80 |
| Xanthan gum | 0.30 | 3.12 |
| Proxel GXL | 0.30 | 3.12 |
| Water | 69.57 | 723.52 |

### Preparation Procedure:

All the stages take place at room temperature about 23° C.±2° C.

### Stage 1—

Spirotetramat, Fenperoxymate, ATLOX 4913, Break Thru s233, Soprophor 3D33, Silcolapse 432 (half the amount) and water (156 g/L) were mixed.
High shear was applied.
The mixture was milled to get the desired particle size distribution LT 6 microns.

### Stage 2—

Extra water (up to 1000 L), silcolapse 432 (half the Amount), propylene glycol, proxel GXL and Xanthan Gum were added; if needed adjust with HCl/NaOH solutions to get pH between 4-6.
The solution was mixed until homogenous suspension was obtained.

### Example 5

TABLE 5
Spirotetramat and fenpyroximate formulation E

| Component | w/w % | g/L |
|---|---|---|
| Spirotetramat tech | 9.62 | 100.00 |
| Fenpyroximate tech | 9.62 | 100.00 |
| Soprophor 3D33 (Tristyrylphenol ethoxylate phosphate | 3.00 | 31.20 |
| ester) | | |
| Break Thru s233 (non-ionic trisiloxane surfactant) | 0.10 | 1.04 |
| Atlox 4913 (Acrylic copolymer solution) | 2.00 | 20.80 |
| Silcolapse 432 (non-ionic, polydimethylsiloxanic oil | 0.50 | 5.20 |
| based, aqueous emulsion) | | |
| Propylene glycol | 7.00 | 72.80 |
| Xanthan gum | 0.30 | 3.12 |
| Proxel GXL | 0.30 | 3.12 |
| Water | 67.57 | 702.72 |

### Preparation Procedure:

All the stages take place at room temperature about 23° C.±2° C.

### Stage 1—

Spirotetramat, Fenperoxymate, ATLOX 4913, Break Thru s233, Soprophor 3D33, Silcolapse 432 (half the amount) and water (156 g/L) were mixed.
High shear was applied.
The mixture was milled to get the desired particle size distribution LT 6 microns.

### Stage 2—

Extra water (up to 1000 L), silcolapse 432 (half the Amount), propylene glycol, proxel GXL and Xanthan Gum were added; if needed adjust with HCl/NaOH solutions to get pH between 4-6.
The solution was mixed until homogenous suspension was obtained.

### Example 6

TABLE 6
Properties of formulations A-E

| | The Entrance | The appearance of the formulation |
|---|---|---|
| Formulation | to the water | in the water after one inversion |
| A | 1.5 | 1.5 |
| B | 1 | 1 |
| C | 1 | 1.5 |
| D | 4 | 3 |
| E | 4 | 3 |

The entrance to the water was rated from 1 to 4, while 1 is the best (smooth entrance to water), and 4 is the worst (non-uniform entrance to water).
The appearance of the formulation in the water after one inversion was rated from 1 to 3, while 1 is the best (small number of tiny lumps or without visible lumps at all), and 3 is the worst (larger number of lumps which are not so small).

It is clearly shown that formulations A-C have better wetting properties than formulations D and E. Formulations A-C are stable after prolonged storage at elevated temperatures or in the cold, and no crystal growth was observed.

### Example 7—Efficacy of Spirotetramat Fenpyroximate Formulations on Mites in Cucumber

### Objective:

Evaluation of efficacy of Spirotetramat and Fenpyroximate SC formulation versus the tank mix for control of Mites in Cucumber.

### Methodology:

One field trail was conducted each trail was designed as a randomized block trail containing 4 treatments and four replications (total 16 plots per trail). 10 plants were evaluated in each plot, all the plants in each replicate were treated with each of the tested formulations.

The prototypes and the commercial products were applied via foliar application on cucumber plants by using blower spray with flow at level 5 (spray volume: 63 l/donam (630 l/ha)).

The treatments were applied during the growing season of mites (avg. Temperature of 25-27° C. relative humidity of 60-80%), following foliar pest infestation level of average of ^{~}2-5 juvenile mites.

The pest evaluation was conducted 0, 3, 7 and 10 days after the application (DAA) on the juvenile stage by counting the mites on the leaves. The number of alive juveniles was documented.

TABLE 7
Treatments in the field

| | | | | Rate/ |
|---|---|---|---|---|
| Treatment | Product | Al | g Al/Ha | Dunam (g) |
| 1 | Spirotetramat (MOVENTO) 100 | Spirotetramat 100 SC | 75 | 75 |
| 2 | Fenpyroximate (meteor) 50 | Fenpyroximate 50 SC | 100 | 200 |
| 3 | Spirotetramat (MOVENTO) 100 + | Spirotetramat 100 SC | 75 + 100 | 75 + 200 |
| | Fenpyroximate (meteor) 50 | Fenpyroximate 50 SC | | |
| 4 | Formulation B | Spirotetramat 75 + | 75 + 100 | 100 |
| | | Fenpyroximate 100 | | |
| | | SC formulation | | |
| | | according to the | | |
| | | invention | | |

TABLE 8
Number of juveniles Mites per 10 leaves in average

| | | juveniles | juveniles | juveniles | juveniles |
|---|---|---|---|---|---|
| | | 26 Jan. | 29 Jan. | 2 Feb. | 5 Feb. |
| | | 2023 | 2023 | 2023 | 2023 |
| | Product/Mix | DOT | 3DAT | 7DAT | 10DAT |
| 1 | Spirotetramat 100 | 1.5BC | 1.0B | 1.6AB | 2.3A |
| 2 | Fenpyroximate 50 | 8.1A | 7.4A | 3.6AB | 3.1A |
| 3 | Spirotetramat 100 + | 6.3AB | 6.5A | 7.4A | 5.5A |
| | Fenpyroximate 50 | | | | |
| 4 | Formulation B | 0.7C | 1.0B | 0.3B | 1.0A |

1. An agrochemical suspension concentrate composition comprising:
a. at least one ketoenol insecticide
b. at least one mitochondrial complex I electron transport inhibitor insecticide
c. a wetting system comprising of:
1. at least one anionic surfactant selected from alkoxylated polyarylphenol, alcohol ethoxylate and or propoxylate phosphate ester, sodium alkyl sulfate, sodium alkyl ether sulfate, alkyl naphthalene sulfonate and alkylbenzene sulfonate;
2. at least one polysiloxane, wherein the ratio of at least one anionic surfactant to at least one polysiloxane is from 0.1:5 to 5:0.1;
3. optionally, at least one additional surfactant;
and
d. water.

2. An agrochemical suspension concentrate composition comprising:
a. at least one ketoenol insecticide
b. at least one mitochondrial complex I electron transport inhibitor insecticide
c. a wetting system comprising of:
1. at least one anionic alkoxylated polyarylphenol
2. at least one polysiloxane
3. at least one additional surfactant;
and
d. water.

3. The composition according to any one of claim 1 or 2, wherein the additional surfactant is selected from sodium dioctyl sulphosuccinate, polysorbate, secondary alcohol ethoxylate and any combination thereof.

4. The composition according to any one of claims 1-3, wherein the ketoenol insecticide is selected from spirotetramat, spidoxamat, spiropidion, spirodiclofen, spiromesifen and any combinations thereof.

5. The composition according to any one of claims 1-4, wherein the mitochondrial complex I electron transport inhibitors insecticide is selected from fenazaquin, fenpyroximate, pyridaben, pyrimidifen, tebufenpyrad, tolfenpyrad and any combinations thereof.

6. The composition according to any one of claims 1-5, wherein the anionic alkoxylated polyarylphenol is selected from alkoxylated polyarylphenol phosphate, alkoxylated polyarylphenol sulphate and any combination thereof.

7. The composition according to claim 6, wherein the alkoxylated polyarylphenol phosphate is alkoxylated tristyrylphenol phosphate.

8. The composition according to claim 7, wherein the alkoxylated tristyrylphenol phosphate is 2,4,6-tris(1-phenylethyl)phenol polyoxyethylenated phosphate.

9. The composition according to claim 8, wherein the number of ethylene oxide unites is about 16.

10. The composition according to claim 6, wherein the alkoxylated polyarylphenol sulphate is selected from alkoxylated distyrylphenol sulphate, alkoxylated tristyrylphenol sulphate and any combination thereof.

11. The composition according to anyone of claims 1-10, wherein the polysiloxane is a polyether modified trisiloxane.

12. The composition according to claim 11, wherein the polyether modified trisiloxane is 3-[methyl-bis(trimethylsilyloxy)silyl]propan-1-ol.

13. The composition according to any one of claims 3-12, wherein the polysorbate is selected from polyoxyethylene sorbitan monolaurate, polyoxyethylene polyoxypropylen sorbitan monolaurate, polyoxyethylene sorbitan monopalmitate, polyoxyethylene sorbitan monostearate, polyoxyethylene sorbitan monooleate or any combination thereof.

14. The composition according to claim 13, wherein the polysorbate is polyoxyethylene sorbitan monolaurate.

15. The composition according to any one of claims 3-14, wherein the secondary alcohol ethoxylate is C11-C15 secondary alcohol ethoxylate.

16. The composition according to any one of claims 1-15, wherein the amount of the ketoenol insecticide is of about 1% to about 60% by weight, based on the total weight of the composition.

17. The composition according to any one of claims 1-16, wherein the amount of the mitochondrial complex I electron transport inhibitors insecticide is of about 1% to about 40% by weight, based on the total weight of the composition.

18. The composition according to any one of claims 1-17, wherein the amount of the anionic alkoxylated polyarylphenol is of about 0.5% to about 7% by weight, based on the total weight of the composition.

19. The composition according to any one of claims 1-18, wherein the amount of polysiloxane is of about 0.05% to about 0.5% by weight, based on the total weight of the composition.

20. The composition according to any one of claims 1-19, wherein the amount of the additional surfactant is of about 0.5% to about 5% by weight, based on the total weight of the composition.

21. The composition according to any one of claims 1-20, wherein the amount of water is of about 10% to about 75% by weight, based on the total weight of the composition.

22. The composition according to any one of claims 1-21, further comprising at least one dispersing agent.

23. The composition according to claim 22, wherein the dispersing agent is selected from sodium polycarboxylates, acrylic copolymers, nonionic alkoxylated polyarylphenol, naphthalene sulfonate condensate or any combination thereof.

24. The composition according to claim 23, wherein the amount of the dispersing agent is of about 1% to about 7% by weight, based on the total weight of the composition.

25. The composition according to any one of claims 1-24, further comprising at least one adjuvant.

26. An agrochemical suspension concentrate composition comprising:
a. spirotetramat
b. fenpyroximate
c. from about 0.5% to about 7% by weight, based on the total weight of the composition of at least one alkoxylated styrenated phenol
d. from about 0.05% to about 0.5% by weight, based on the total weight of the composition of at least one polyether modified trisiloxane
e. from about 0.5% to about 5% by weight, based on the total weight of the composition of sodium dioctyl sulphosuccinate and/or at least one polyoxyethylenesorbitan monolaurate and
f. water.
